(19) United States
(12) Patent Application Publication
(10) Pub. No.: US 2024/0230308 A9
(43) Pub. Date: Jul. 11, 2024

(54) COIL STRUCTURES FOR INDUCTIVE ANGULAR-POSITION SENSING

(71) Applicant: Microchip Technology Incorporated, Chandler, AZ (US)

(72) Inventors: Ganesh Shaga, Warangal (IN); Kevin Mark Smith, Dana Point, CA (US); Hwangsoo Choi, La Habra, CA (US); Surendra Akkina, Hyberabad (IN); Sudheer Puttapudi, Hyderabad (IN)

(21) Appl. No.: 18/490,039

(22) Filed: Oct. 19, 2023

(30) Foreign Application Priority Data
Oct. 19, 2022 (IN) 202241059649

(51) Int. Cl. G01B 7/30; G01D 5/20

(52) U.S. Cl. CPC G01B 7/30; G01D 5/20

(57) ABSTRACT

An apparatus comprises a target to rotate about an axis; an excitation coil to carry an excitation signal; and a first sense coil to carry a sense signal induced by the excitation signal. The first sense coil comprises two or more lobes in one or more planes that are perpendicular to the axis. The two or more lobes comprise a first lobe at a first position relative to the axis and a second lobe at a second position relative to the axis. The second position is substantially the same radial distance from the axis as the first position is from the axis. The second position is at an angular distance of Θ from the first position, where Θ=180°±α/2, and α is a measurement range for angular-position sensing (e.g., α=60°) within a range of 50% to 150% of α.

### CROSS-REFERENCE TO RELATED APPLICATION

This application claims the benefit of the priority date of Indian Provisional Patent Application No. 202241059649, filed Oct. 19, 2022, and titled “REDUNDANT INDUCTIVE POSITION SENSOR COIL STRUCTURE WITH TARGET OFF AXIS COMPENSATION,” the disclosure of which is incorporated herein in its entirety by this reference.

### FIELD

This invention relates generally to inductive angular-position sensing. More specifically, some examples relate to inductive angular-position sensors for measuring the position of a movable target, without limitation. Additionally, devices, systems, and methods are disclosed.

### BACKGROUND

If a coil of wire is placed in a changing magnetic field, a voltage will be induced at ends of coil of wire. In a predictably changing magnetic field, the induced voltage will be predictable (based on factors including the area of the coil affected by the magnetic field and the degree of change of the magnetic field). It is possible to disturb a predictably changing magnetic field and measure a resulting change in the voltage induced in the coil of wire. Further, it is possible to create a sensor that measures movement of a disturber of a predictably changing magnetic field based on a change in a voltage induced in a coil of wire.

### BRIEF DESCRIPTION OF THE DRAWINGS

While this disclosure concludes with claims particularly pointing out and distinctly claiming specific examples, various features and advantages of examples within the scope of this disclosure may be more readily ascertained from the following description when read in conjunction with the accompanying drawings, in which:

FIG. 1A is a top down view of a front side of an apparatus for inductive angular-position sensing of a target, according to one or more examples of the disclosure.

FIG. 1B is a top down view of a reverse side of the apparatus of FIG. 1A with the target removed.

FIG. 2 is a close-up view of a first coil structure for a first inductive angular-position sensor (“Sensor U1”) and a second coil structure for a second inductive angular-position sensor (“Sensor U2”) of the apparatus of FIGS. 1A-1B, indicating circular arc sections within which the first and the second coil structures may be arranged or distributed according to one or more examples.

FIG. 3A is a top down view of the first coil structure of the first inductive angular-position sensor (“Sensor U1”) of the apparatus, according to one or more examples.

FIG. 3B is a top down view of the second coil structure of the second inductive angular-position sensor (“Sensor U2”) of the apparatus, according to one or more examples.

FIG. 4A is a top down view of the first coil structure of the first inductive angular-position sensor, removed and separated from both a support structure and other coil structures for illustrative clarity, according to one or more examples.

FIG. 4B is a top down view of an excitation coil of the first coil structure of the first inductive angular-position sensor, removed and separated from both the support structure and other coil structures for illustrative clarity, according to one or more examples.

FIGS. 4C and 4D are top down views of a first sense coil of the first coil structure, removed and separated from both the support structure and other coil structures for illustrative clarity, according to one or more examples.

FIGS. 4E and 4F are top down views of a second sense coil of the first coil structure, removed and separated from both the support structure and other coil structures for illustrative clarity, according to one or more examples.

FIG. 4G is a top down view of the first coil structure of the first inductive angular-position sensor, indicating various positions and angles associated with lobes of the first and the second sense coils, according to one or more examples.

FIG. 5A is a top down view of a first lobe of the first sense coil of the first coil structure, according to one or more examples.

FIG. 5B is a top down view of a second lobe of the first sense coil of the first coil structure, according to one or more examples.

FIG. 6A is a top down view of the apparatus for inductive angular-position sensing of FIG. 1A, where the target is substantially “on-axis” and/or generally centered with respect to the axis of rotation.

FIG. 6B is a top down view of the apparatus for inductive angular-position sensing of FIG. 6A, where the target is positioned off-axis with respect to the axis of rotation.

FIG. 7 is a plot diagram of plots of simulation results associated with sensor accuracy of different sensor approaches having targets that are off-axis.

FIG. 8 is a plot diagram of plots of various simulation results for comparison of typical sensor data and target off-axis sensor data associated with known sensor approaches.

FIG. 9 is a plot diagram of sine and cosine signal profiles with and without target off-axis displacement for an apparatus for inductive angular-position sensing according to one or more examples of the disclosure.

FIG. 10 is a block diagram of circuitry that, in some examples, may be used to implement various functions, operations, acts, processes, and/or methods disclosed herein.

### DETAILED DESCRIPTION

In the following detailed description, reference is made to the accompanying drawings, which form a part hereof, and in which are shown, by way of illustration, specific examples of examples in which the present disclosure may be practiced. These examples are described in sufficient detail to enable a person of ordinary skill in the art to practice the present disclosure. However, other examples may be utilized, and structural, material, and process changes may be made without departing from the scope of the disclosure.

The illustrations presented herein are not meant to be actual views of any particular method, system, device, or structure, but are merely idealized representations that are employed to describe the examples of the present disclosure. The drawings presented herein are not necessarily drawn to scale. Similar structures or components in the various drawings may retain the same or similar numbering for the convenience of the reader; however, the similarity in numbering does not mean that the structures or components are necessarily identical in size, composition, configuration, or any other property.

The following description may include examples to help enable one of ordinary skill in the art to practice the disclosed examples. The use of the terms “exemplary,” “by example,” and “for example,” means that the related description is explanatory, and though the scope of the disclosure is intended to encompass the examples and legal equivalents, the use of such terms is not intended to limit the scope of an example of this disclosure to the specified components, steps, features, functions, or the like.

It will be readily understood that the components of the examples as generally described herein and illustrated in the drawing could be arranged and designed in a wide variety of different configurations. Thus, the following description of various examples is not intended to limit the scope of the present disclosure, but is merely representative of various examples. While the various aspects of the examples may be presented in drawings, the drawings are not necessarily drawn to scale unless specifically indicated.

Furthermore, specific implementations shown and described are only examples and should not be construed as the only way to implement the present disclosure unless specified otherwise herein. Elements, circuits, and functions may be depicted by block diagram form in order not to obscure the present disclosure in unnecessary detail. Conversely, specific implementations shown and described are exemplary only and should not be construed as the only way to implement the present disclosure unless specified otherwise herein. Additionally, block definitions and partitioning of logic between various blocks is exemplary of a specific implementation. It will be readily apparent to one of ordinary skill in the art that the present disclosure may be practiced by numerous other partitioning solutions. For the most part, details concerning timing considerations and the like have been omitted where such details are not necessary to obtain a complete understanding of the present disclosure and are within the abilities of persons of ordinary skill in the relevant art.

Those of ordinary skill in the art would understand that information and signals may be represented using any of a variety of different technologies and techniques. For example, data, instructions, commands, information, signals, bits, and symbols that may be referenced throughout this description may be represented by voltages, currents, electromagnetic waves, magnetic fields or particles, optical fields or particles, or any combination thereof. Some drawings may illustrate signals as a single signal for clarity of presentation and description. It will be understood by a person of ordinary skill in the art that the signal may represent a bus of signals, wherein the bus may have a variety of bit widths and the present disclosure may be implemented on any number of data signals including a single data signal. A person having ordinary skill in the art would appreciate that this disclosure encompasses communication of quantum information and qubits used to represent quantum information.

The various illustrative logical blocks, modules, and circuits described in connection with the examples disclosed herein may be implemented or performed with a general purpose processor, a special purpose processor, a Digital Signal Processor (DSP), an Integrated Circuit (IC), an Application Specific Integrated Circuit (ASIC), a Field Programmable Gate Array (FPGA) or other programmable logic device, discrete gate or transistor logic, discrete hardware components, or any combination thereof designed to perform the functions described herein. A general-purpose processor (may also be referred to herein as a host processor or simply a host) may be a microprocessor, but in the alternative, the processor may be any conventional processor, controller, microcontroller, or state machine. A processor may also be implemented as a combination of computing devices, such as a combination of a DSP and a microprocessor, a plurality of microprocessors, one or more microprocessors in conjunction with a DSP core, or any other such configuration. A general-purpose computer including a processor is considered a special-purpose computer while the general-purpose computer is configured to execute computing instructions (e.g., software code) related to examples of the present disclosure.

The examples may be described in terms of a process that is depicted as a flowchart, a flow diagram, a structure diagram, or a block diagram. Although a flowchart may describe operational acts as a sequential process, many of these acts can be performed in another sequence, in parallel, or substantially concurrently. In addition, the order of the acts may be re-arranged. A process may correspond to a method, a thread, a function, a procedure, a subroutine, or a subprogram, without limitation. Furthermore, the methods disclosed herein may be implemented in hardware, software, or both. If implemented in software, the functions may be stored or transmitted as one or more instructions or code on computer-readable media. Computer-readable media includes both computer storage media and communication media including any medium that facilitates transfer of a computer program from one place to another.

Position sensors, including angular-position sensors are useful. Some examples relate to relates to a non-contacting planar inductive sensor for measuring the position of a movable target. There are many advantages to planar inductive sensing technology, such as: contactless sensing technology, easily designed on printed circuit board (PCB) with a metallic object (e.g., formed of a metal sheet) as target, suitable for harsh environments, cost effective, resistance to magnetic fields, immune to electromagnetic interference (EMI)/electromagnetic compatibility (EMC).

There is demand for position sensors that are light-weight, low cost, reliable, and/or noise immune or resistant. One option is inductive position sensors.

An inductive angular-position sensor may include an oscillator, one or more oscillator coils or excitation coils, a first sense coil, a second sense coil, and an integrated circuit (e.g., including processing circuitry). Such an inductive angular-position sensor may determine an angular-position of a target relative to the one or more oscillator coils and/or the sense coils.

The oscillator may be configured to generate an excitation signal. The one or more oscillator coils may be excited by the excitation signal. The oscillating signal on the one or more oscillator coils may generate a changing (alternating) magnetic field near and especially within a space encircled by the oscillator coil.

The first sense coil and the second sense coil may each encircle a space in which the one or more oscillator coils are capable of generating magnetic field, e.g., a space within the space encircled by the one or more oscillator coils. The changing magnetic field generated by the one or more oscillator coils may induce a first oscillating voltage at ends of the first sense coil and a second oscillating voltage at ends of the second sense coil. The first oscillating voltage at the ends of the first sense coil may oscillate in response to the oscillation of the excitation signal and may be a first sense signal. The second oscillating voltage at the ends of the second sense signal may oscillate in response to the oscillation of the excitation signal and may be a second sense signal.

The target may be positioned relative to the one or more oscillator coils, the first sense coil, and the second sense coil. For example, the target, or a portion of the target, may be positioned above a portion of the one or more oscillator coils, the first sense coil, and the second sense coil, without limitation. The target may disrupt some of the changing magnetic field that passes through one or more loops of the first sense coil and the second sense coil.

The first sense coil and the second sense coil may be configured such that the location of the target, or the portion of the target, above one or more of the first sense coil and the second sense coil may affect the first sense signal and the second sense signal induced in the first sense coil and the second sense coil respectively. For example, the target may disrupt magnetic coupling between the oscillator coil and the sense coils. Such disruption may affect a magnitude of the sense signals in the sense coils. For example, in response to the target, or a the portion of the target, being over a loop in the first sense coil, the amplitude of the first sense signal may be less than the amplitude of the first sense signal when the target is not over the loop in the first sense coil.

Further, the target may be configured to rotate (e.g., around an axis, without limitation) such that a portion of the target may pass over one or more loops of one or more of the one or more oscillator coils, the first sense coil and the second sense coil. As the target rotates, each of the first sense signal of the first sense coil and the second sense signal of the second sense coil may be amplitude modulated in response to the rotation of the target and in response to the portion of the target passing over the loops.

In various examples, the integrated circuit may be configured to generate an output signal responsive to the first sense signal and the second sense signal. The output signal may be a fraction of a rail voltage based on the first sense signal and the second sense signal. The output signal may be related to an angular-position of the target, or the position of the portion of the target, and successive samples of the output signal may be related to a direction of movement of the target. Thus, the inductive angular-position sensor may be configured to generate an output signal indicative of an angular-position of a target.

In various examples, the integrated circuit may be configured to generate a first output signal based on the first sense signal and a second output signal based on the second sense signal. The first output signal may be the first sense signal demodulated; the second output signal may be the second sense signal demodulated. Together, the two output signals may be related to an angular-position of the target and subsequent samples of the first and second output signals may be indicative of rotation of the target.

In various examples, the integrated circuit may be configured to generate a single output signal based on the first sense signal and the second sense signal. Some examples include sense coils and/or targets that cause an integrated circuit to generate a constant-slope output signal in response to rotation of the target, relative to the first sense coil and the second sense coil. The constant-slope output signal may be an output signal with a known correlation between an amplitude of the output signal and the angular-position of the target.

Various examples of the present disclosure may include elements of inductive angular-position sensors (including, e.g., sense coils and targets) which may allow such inductive angular-position sensors to provide a more accurate correlation between output signals and the angular-position of the target relative to the sense coils. In other words, various examples of the present disclosure may include elements for inductive angular-position sensors that may cause the inductive angular-position sensors to be more accurate than other inductive angular-position sensors. Additionally or alternatively, various examples may include inductive angular-position sensors that are more accurate than other inductive angular-position sensors.

As a non-limiting example, various examples may include targets and/or sense coils having a shapes that may cause sense signals from the respective sense coils to exhibit desirable waveform shapes, e.g., waveform shapes that are close-to-ideal waveform shapes. The shapes of targets and/or path portions of the sense coils may be related to how the sense signals generated therein are amplitude modulated as a target disrupts magnetic field between the oscillator coil and the sense coils. As a non-limiting example, as a target rotates above sense coils and disrupts the magnetic field between the oscillator coil and the sense coils, the shape of the target and/or the sense coils may determine the shape of an amplitude-modulation envelope exhibited by the sense signals. As a non-limiting example, an amplitude-modulation envelope of sense signals of sense coils of various examples may be close to a sinusoidal shape. A sinusoidally-shaped amplitude-modulation envelope may be well-suited for translation into an angular-position e.g., through a trigonometric function e.g., arctangent.

Various examples of the disclosure may provide redundancy in angular-position sensing by including multiple sensors. Such redundancy may be desirable in safety-sensitive or safety-critical applications. A respective one the multiple sensors may include one or more oscillator coils and sense coils. The oscillator and sense coils of a respective sensor may be independent of the oscillator and sense coils of the other sensor(s), with relatively little mutual coupling therebetween.

Various examples may provide redundancy in angular-position sensing that is more reliable and/or less prone to failure. In one or more examples, the oscillator and sense coils of a respective one of the multiple sensors may be physically separate from the oscillator and sense coils of the other sensor(s). For example, the oscillator and sense coils of a respective sensor may not be laid over, or under, the oscillator and sense coils of the other sensors. In contrast, some conventional redundant sensors include oscillator coils that are stacked, one above the other. In some particular instances, a pin level short between the stacked oscillator coils may cause both of the sensors to fail.

Various examples of the disclosure provide accurate results for angular-position sensing despite a target of the sensor being “off-axis.” An off-axis condition exists where an axis of rotation of the target does not coincide with, or is shifted relative to, its intended position relative to (e.g., a center) of the sense coils. In some cases, an off-axis condition may be due to (e.g., relatively looser) tolerances associated with the target mechanical assembly and develop over a relatively long period of operation. In some conventional sensors, accuracy in angular-position sensing may be compromised if the target is off-axis (e.g., the calculation of angular-position of the target may be inaccurate). For example, an off-axis target may shadow one or more lobes of the coils in a way that is inconsistent relative to the other lobes. Various examples of the disclosure include coil structures arranged such that, even if a target is off-axis, causes the target to shadow its lobes in a way that allows the sensor to accurately determine its angular-position.

Various examples of the disclosure are provided for applications that require angular-position sensing that is more accurate and/or tolerant to off-axis targets. For example, various examples of the disclosure may be provided for motor control applications (e.g., for rotor position sensing of motors, where the sensors are mounted inside an assembly). Various examples of the disclosure may be provided for through-shaft sensing with low form-factor PCBs. However, the various examples of the disclosure are not limited to these applications.

Various examples of the disclosure include two cycles of a 60° sensor or a six (6) pole pair sensor, for generating two repetitive position sensor outputs. Here, a full 360° rotation of the target may result in two cycles of a position output signal and/or two cycles of sense signals. Note that the symbol “°” is used herein to represent “degree” and “degrees,” which are a measurement of a plane angle in which a full rotation is 360°. However, examples of the disclosure are not limited to sensors having a certain number of poles or lobes. In one or more other examples, a different number of poles or lobes may be used. For example, an inductive angular-position sensor of the disclosure may include a three pole pair sensor, a five pole pair sensor, and/or a six pole pair sensor, and so on, without limitation.

In one or more examples, the target may play a role in a proper coupling between the static sensor and the rotating target. A target that covers an area encircled by lobes of the sense coil that change according to a sinusoidal pattern may allow the sensor to produce more accurate results. For example, if a total area substantially encircled by a sense coil is mapped as a function of target rotation, an area that follows a sinusoidal curve as a function of rotation angle may allow the sensor to produce accurate position results.

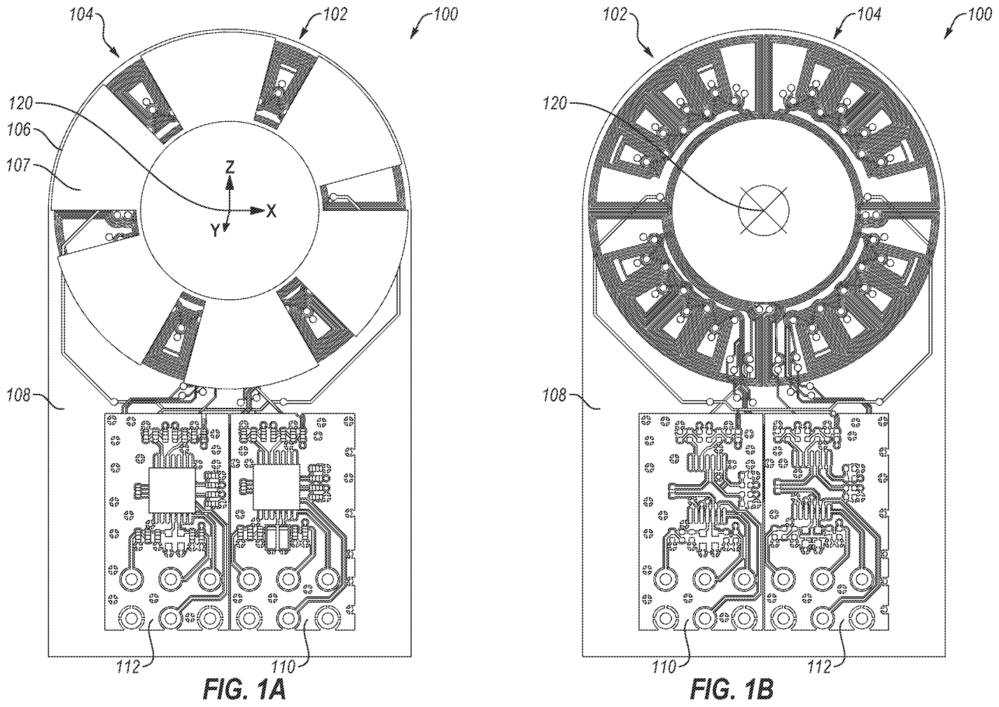

FIG. 1A is a top down view of a front side of an apparatus 100 according to one or more examples of the disclosure. In one or more examples, apparatus 100 is an inductive angular-position sensing apparatus to sense an angular-position of a target 106 that rotates around an axis 120. FIG. 1B is a top down view of a reverse side of apparatus 100 of FIG. 1A with the target removed.

More specifically, in one or more examples, apparatus 100 is a redundant inductive angular-position sensing apparatus including two or more inductive angular-position sensors to sense the angular-position of target 106. In a specific, non-limiting example, apparatus 100 may be a redundant inductive angular-position sensing apparatus including a first inductive angular-position sensor and a second inductive angular-position sensor.

Accordingly, apparatus 100 may include at least a first coil structure 102 for a first inductive angular position sensor and a second coil structure 104 for a second inductive angular position sensor. First coil structure 102 is at least partially formed by or includes conductive traces on and/or in one or more planes (e.g., multiple planes) of a support structure 108. Similarly, second coil structure 104 is at least partially formed by or includes conductive traces on and/or in the one or more planes (e.g., multiple planes) of support structure 108.

In one or more examples, support structure 108 may be or include a substrate, such as a printed circuit board (PCB). When multiple planes are used for coil arrangements, the multiple planes may be parallel planes at different heights of the substrate. For example, a respective one of the multiple planes may be associated with a different one of multiple layers of a PCB.

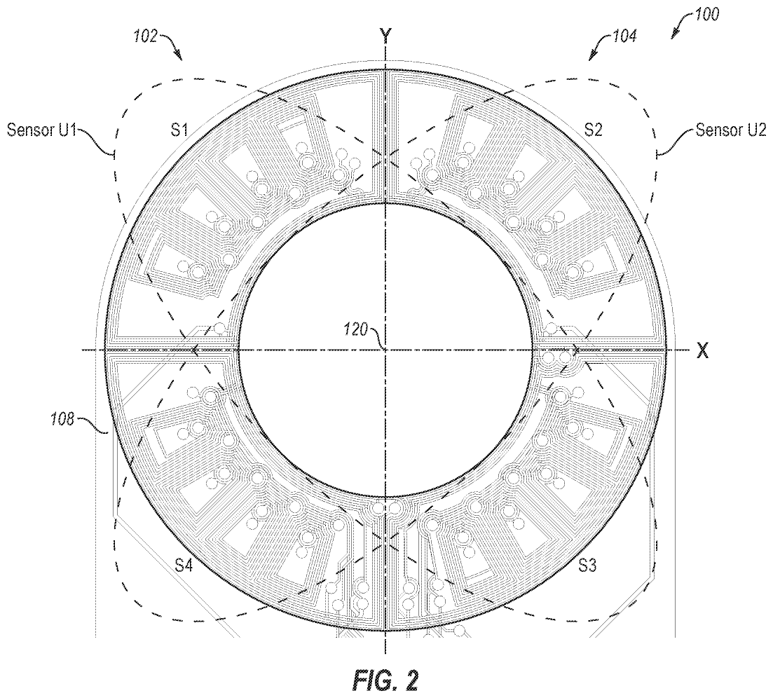

FIG. 2 is a close-up view of first and second coil structures 102 and 104 indicating circular arc sections within which first and second coil structures 102 and 104 may be arranged or distributed according to one or more examples. In the example of FIG. 2, a circular portion of support structure 108 is shown as being divided into four (4) circular arc or arc band sections (e.g., indicated as S1, S2, S3, and S4 in clockwise order). In one or more examples, the circular arc or arc band sections may be associated with or part of four (4) quadrant sections of support structure 108. The respective arc band sections (e.g., S1, S2, S3, and S4) or quadrants (alternatively, e.g., Q1, Q2, Q3, and Q4) may be defined relative to two perpendicular lines, crossing at axis 120, in a plane of the one or more planes of support structure 108. In one or more examples, the first quadrant is opposite the third quadrant and adjacent the first and the second quadrants; the second quadrant is opposite the fourth quadrant and adjacent the first and the third quadrants; and so on.

In FIG. 2, first coil structure 102 of the first inductive angular-position sensor (indicated as “Sensor U1” in the figure) is generally located within a first dashed oval shape. In one or more examples, first coil structure 102 is arranged or distributed within both the first arc band section (S1) and the third arc band section (S3). On the other hand, second coil structure 104 of the second inductive angular-position sensor (indicated as “Sensor U2” in the figure) is generally located within a second dashed oval shape. In one or more examples, second coil structure 104 is arranged or distributed within both arc band section two (S2) and arc band section four (S4).

Although not referenced in FIG. 2, a respective one of the first and the second coil structures 102 and 104 includes an excitation coil, a first sense (e.g., sine) coil, and a second sense (e.g., cosine) coil. The excitation coil may be referred to as a primary coil, and the first and the second sense coils may be referred to as secondary coils.

With reference back to FIGS. 1A-1B, target 106 has a target body which is generally planar (i.e., in-plane with the page) and circular. In one or more examples, target 106 includes multiple fins (such as a fin 107) that are evenly radially spaced around axis 120. In FIG. 1A, axis 120 is shown as the Z-axis in a three-dimensional coordinate axis system (X-Y-Z). In the specific, non-limiting example, the number of fins of target 106 is six (6). In one or more examples, the (e.g., six) multiple fins of target 106 are equally-radially spaced about axis 120, at 60° intervals. In one or more examples, the multiple fins of target 106 define gaps between respective adjacent fins, and a respective one of the gaps is substantially the same size (e.g., measured circumferentially around axis 120) as a (e.g., single) lobe of the first and the second sense coils as shown.

The target body of target 106 may be made of a conductive material, such as a non-magnetic conductive metal or metal alloy, without limitation. In one or more examples, the non-magnetic conductive metal or metal alloy may be or include copper or aluminum. In one or more other examples, the target body of target 106 may be made of a magnetic conductive metal or metal alloy, such as carbon steel or terrific stainless steel, without limitation. Here, an oscillator may generate an excitation signal within a certain range of frequencies (e.g., 1-6 MHz, without limitation) that the magnetic domains of the magnetic conductive metals or metal alloys will not react to.

When apparatus 100 is in operational use, target 106 rotates around axis 120 (e.g., target 106 may be connected to a through-shaft which may extend through support structure 108). Target 106 may disrupt magnetic coupling between the excitation coil and the first and the second sense coils of the sensor, such that sense signals induced in the first and the second sense coils are indicative of an angular-position of target 106 as it rotates around axis 120. The degree to which target 106 disrupts magnetic coupling between the excitation coil and the first and the second sense coils may vary at least partially in response to changes in the angular-position of target 106.

For angular-position sensing of target 106, the first inductive angular-position sensor may include processing circuitry 112. Similarly, the second inductive angular-position sensor may include processing circuitry 110 for angular-position sensing. In one or more examples, processing circuitry 112 of the first inductive angular-position sensor may be or include a sensor IC (FIG. 1A), and processing circuitry 110 of the second inductive angular-position sensor may be or include a sensor IC (FIG. 1A).

During operation, the processing circuitry generates a high frequency signal to excite the excitation coil for producing an alternating magnetic field. The magnetic field couples onto the first and the second sense coils for generating a voltage. As target 106 disturbs the generated magnetic field, the first and the second sense coils will receive different voltages versus target position. When there is no target, voltage induced in the coils will be zero. When target 106 is present and is rotating, it creates modulated sine and cosine waveforms given as feedback signals to the processing circuitry (e.g., the IC). Internal to the IC, the signals are demodulated, and position information may be calculated, for example, by taking an arc tan 2 function of the ratio of the two sense signals, which may be sine and cosine signals. The sine and cosine signals may be close to ideal sine and cosine waveforms, resulting in relatively high accuracy and resolution.

With respect to FIG. 2, first and second coil structures 102 and 104 of apparatus 100 are arranged to generate sense signals that repeat with every 60° of rotation of the target. For example, the sense signals may include two (2) repeated signal portions. The two repeated signal portions may correspond to two (2) repeated portions of the target and/or to four (4) substantially circumferentially-symmetric lobes of the sense coils.

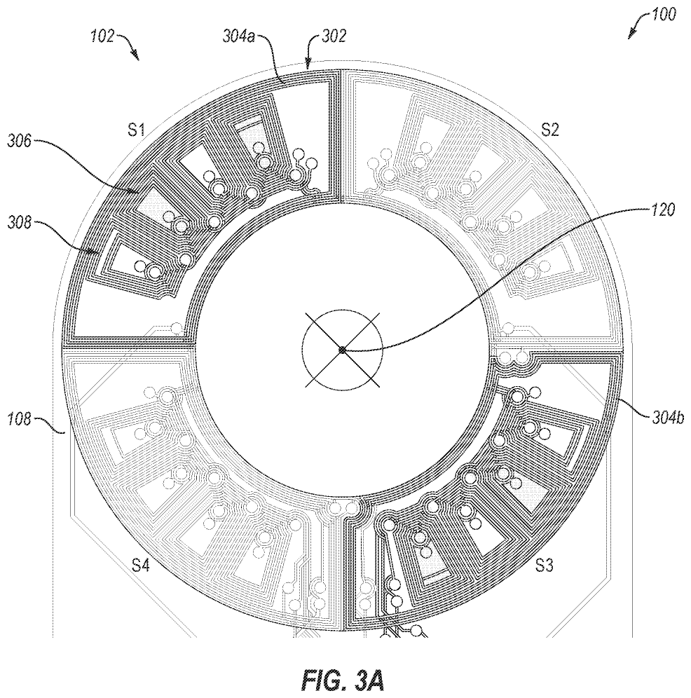

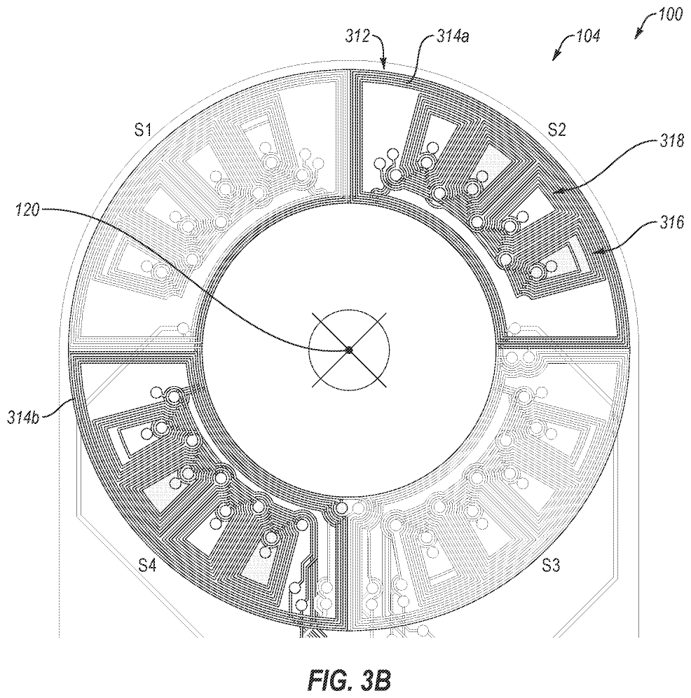

FIG. 3A is a top down view of first coil structure 102 of the first inductive angular-position sensor (“Sensor U1”) of apparatus 100, according to one or more examples. In one or more examples, first coil structure 102 includes an excitation coil 302, a first sense coil 306, and a second sense coil 308.

Excitation coil 302 includes a first excitation coil portion 304a and a second excitation coil portion 304b. In one or more examples, first excitation coil portion 304a is arranged around the first arc band section (S1) of the support structure, and second excitation coil portion 304b is arranged around the third arc band section (S3) of the support structure. In one or more examples, the third arc band section is opposite (e.g., substantially 180° away from, without limitation) the first arc band section.

In one or more examples, a respective one of the first and the second excitation coil portions 304a and 304b may have the shape of an arc band-shaped ring. In one or more examples, the structure includes an inner-circumferential portion defining a respective arc of a first circle centered at axis 120; an outer-circumferential portion defining a respective arc of a second circle centered at the axis, where the second circle is larger than the first circle; and radial portions between respective ends of the inner-circumferential portion and the outer-circumferential portion.

First sense coil 306 includes two or more lobes arranged or distributed within first and second excitation coil portions 304a and 304b. In FIG. 3A, the two or more lobes of first sense coil 306 are highlighted to distinguish them from the lobes of second sense coil 308. In the specific, non-limiting example shown in FIG. 3A, first sense coil 306 includes four (4) lobes, including two (2) lobes in the first arc band section (S1) and two (2) lobes in the third arc band section (S3), in the arrangement shown in FIG. 3A.

Second sense coil 308 also includes two or more lobes arranged or distributed within first and second excitation coil portions 304a and 304b. In FIG. 3A, the two or more lobes of second sense coil 308 are not highlighted to distinguish them from the lobes of first sense coil 306. In the specific, non-limiting example shown in FIG. 3A, second sense coil 308 includes four (4) lobes, including two (2) lobes in the first arc band section (S1) and two (2) lobes in the third arc band section (S3), in the arrangement shown in FIG. 3A. As is apparent, in one or more examples, the lobes of second sense coil 308 are arranged to alternate with lobes of first sense coil 306 within the first and the fourth arc band sections.

As shown, first excitation coil portion 304a is arranged to substantially surround the lobes of first and second sense coils 306 and 308 in the first arc band section (e.g., where first excitation coil portion 304a and its associated lobes are located in the first quadrant). On the other hand, second excitation coil portion 304b is arranged to substantially surround the lobes of first and second sense coils 306 and 308 in the third arc band section (e.g., where second excitation coil portion 304b and its associated lobes are located in the third quadrant).

In one or more examples, a gap having a circumferential width of about one (1) lobe width is provided between respective ones of the radial portions of first and second excitation coil portions 304a and 304b of first coil structure 102 and a nearest lobe within the excitation coil. Similarly, in one or more examples, a gap having a circumferential width of about one (1) lobe width is provided between edges of respective adjacent fins of an associated target (e.g., target 106 of FIG. 1A), so that a (e.g., full) single lobe may be exposed through respective gaps of the target.

As is apparent from FIG. 3A, in one or more examples, first coil structure 102 is patterned to provide a measurement range of 60° with a 90° phase-shift between sine and cosine patterns. However, other suitable patterns for first coil structure 102 may be provided with different measurement ranges (e.g., less than or equal to 90°, such as 90°, 30°, and so on) and/or phase-shifts as one skilled in the art would readily appreciate.

FIG. 3B is a top down view of second coil structure 104 of the second inductive angular-position sensor (“Sensor U2”) of apparatus 100, according to one or more examples. In one or more examples, second coil structure 104 includes an excitation coil 312, a third sense coil 316, and a fourth sense coil 318.

Excitation coil 312 includes a third excitation coil portion 314a and a fourth excitation coil portion 314b. In one or more examples, third excitation coil portion 314a is arranged around the second arc band section (S2) of the support structure, and fourth excitation coil portion 314b is arranged around the fourth arc band section (S4) of the support structure. In one or more examples, the fourth arc band section is opposite (e.g., substantially 180° away from, without limitation) the second arc band section.

In one or more examples, a respective one of the third and the fourth excitation coil portions 314a and 314b may have the shape of an arc band-shaped ring. In one or more examples, the structure includes an inner-circumferential portion defining a respective arc of a first circle centered at axis 120; an outer-circumferential portion defining a respective arc of a second circle centered at the axis, where the second circle is larger than the first circle; and radial portions between respective ends of the inner-circumferential portion and the outer-circumferential portion.

Third sense coil 316 includes two or more lobes arranged or distributed within third and fourth excitation coil portions 314a and 314b. In FIG. 3B, the two or more lobes of third sense coil 316 are highlighted to distinguish them from the lobes of fourth sense coil 318. In the specific, non-limiting example shown in FIG. 3B, third sense coil 316 includes four (4) lobes, including two (2) lobes in the second arc band section (S2) and two (2) lobes in the fourth arc band section (S4), in the arrangement shown in FIG. 3B.

Fourth sense coil 318 also includes two or more lobes arranged or distributed within third and fourth excitation coil portions 314a and 314b. In FIG. 3B, the two or more lobes of fourth sense coil 318 are not highlighted to distinguish them from the lobes of third sense coil 316. In the specific, non-limiting example shown in FIG. 3B, fourth sense coil 318 includes four (4) lobes, including two (2) lobes in the second arc band section (S2) and two (2) lobes in the fourth arc band section (S4), in the arrangement shown in FIG. 3B.

As shown, third excitation coil portion 314a is arranged to substantially surround the lobes of third and fourth sense coils 316 and 318 in the second arc band section (e.g., where third excitation coil portion 314a and its associated lobes are located in the second quadrant). On the other hand, fourth excitation coil portion 314b is arranged to substantially surround the lobes of third and fourth sense coils 316 and 318 in the fourth arc band section (e.g., where fourth excitation coil portion 314b and its associated lobes are located in the fourth quadrant). In one or more examples, a gap having a circumferential width of about one (1) lobe width is provided between respective ones of the radial portions of third and fourth excitation coil portions 314a and 314b of second coil structure 104 and a nearest lobe within the excitation coil.

As is apparent from FIG. 3B, in one or more examples, second coil structure 104 is patterned to provide a measurement range of 60° with a 90° phase-shift between sine and cosine patterns. However, other suitable patterns for second coil structure 104 may be provided with different measurement ranges (e.g., less than or equal to 90°, such as 90°, 30°, and so on) and/or phase-shifts as one skilled in the art would readily appreciate.

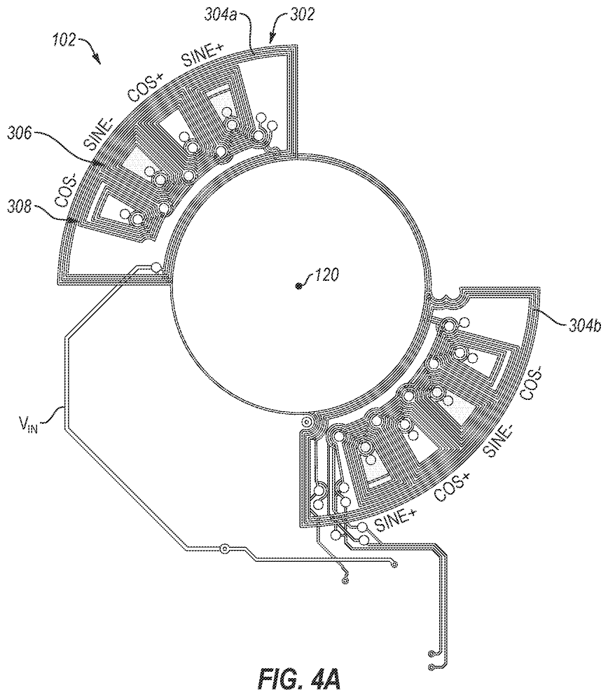

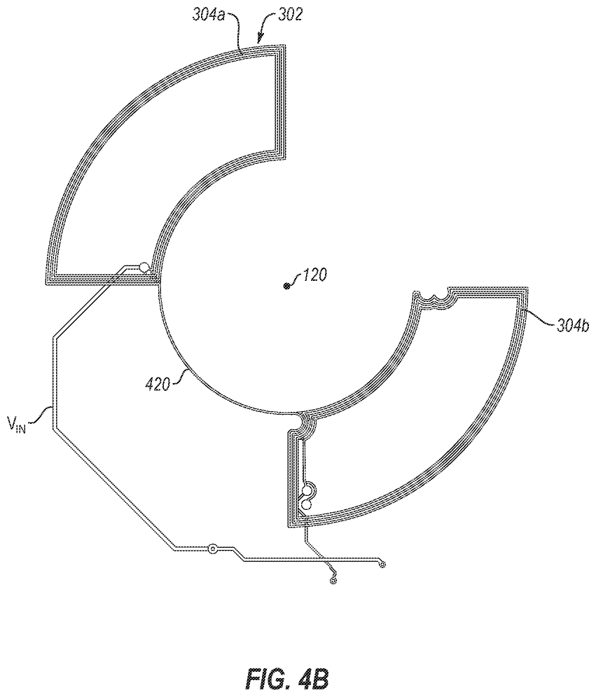

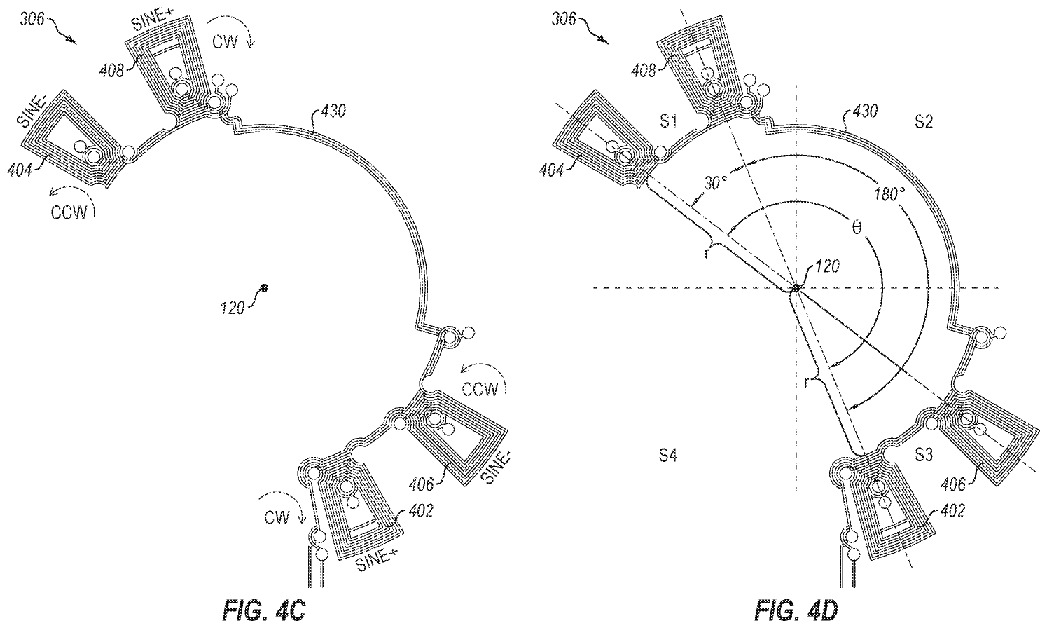

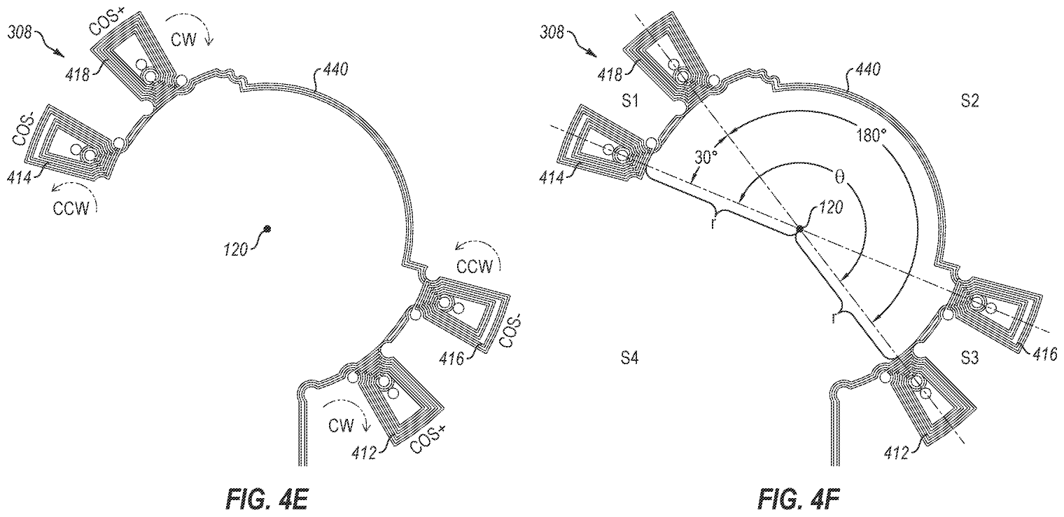

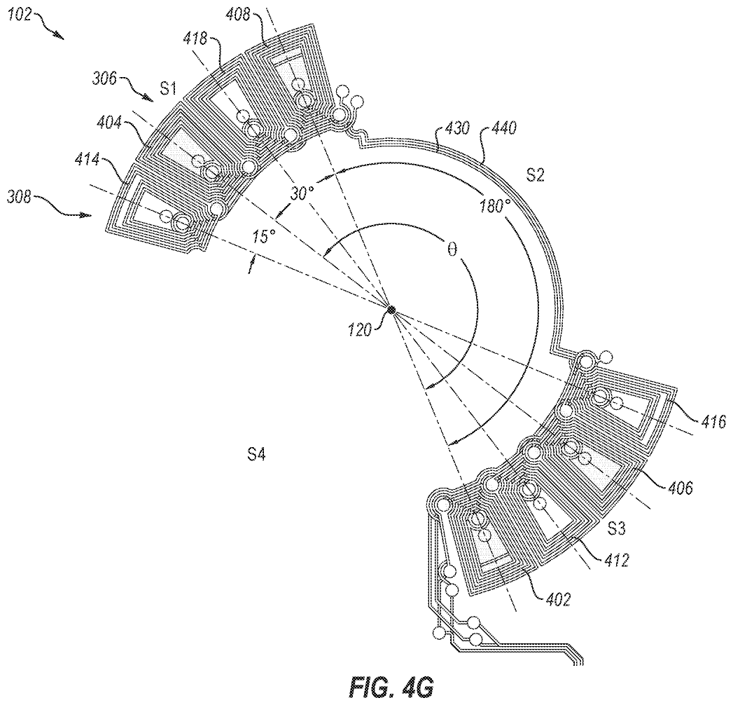

FIG. 4A is a top down view of first coil structure 102 of the first inductive angular-position sensor removed and separated from both the support structure and other coil structures for illustrative clarity.

FIG. 4B is a top down view of excitation coil 302 of the first coil structure of the first inductive angular-position sensor removed and separated from both the support structure and other coil structures for illustrative clarity. As shown, an entry trace segment for VIN extends to provide a “center tap” coupling to excitation coil 302 (e.g., at first excitation coil portion 304a in FIG. 4B) for excitation of first and second excitation coil portions 304a and 304b. Given the center tap coupling, the alternating magnetic field of second excitation coil portion 304b will be out-of-phase with that of first excitation coil portion 304a (e.g., 180° out-of-phase). In addition to the entry and exit trace segments to and from excitation coil 302, a connecting trace segment 420 extends circumferentially to connect first excitation coil portion 304a and second excitation coil portion 304b of excitation coil 302.

FIGS. 4C and 4D are top down views of first sense coil 306 of the first coil structure removed and separated from both the support structure and other coil structures for illustrative clarity.

First sense coil 306 of the first coil structure is shown to include two or more lobes 404 and 408 in the first arc band section (S1) (FIG. 4D) and two or more lobes 402 and 406 in the third arc band section (S3) (FIG. 4D). In one or more examples, a respective one of the lobes may have a generally trapezoidal or rectangular shape as shown, or any other suitable shape (e.g., a sinusoidal shape). In one or more examples, first sense coil 306 of the first coil structure is a sine sense coil, where lobes 402 and 408 are positive sine lobes (indicated as “SINE+”) and lobes 404 and 406 are negative sine lobes (indicated as “SINE−”). In one or more examples, lobes 402 and 408 that are positive sine lobes (“SINE+”) include inwardly-spiraling clockwise “CW” turns, and lobes 404 and 406 that are negative sine lobes (“SINE−”) include inwardly-spiraling counter-clockwise “CCW” turns. In addition to entry and exit trace segments to and from lobe 402 of first sense coil 306 (e.g., more fully illustrated in FIG. 4A), connecting trace segments 430 extend circumferentially to connect lobe 406 in the third arc band section to lobe 408 in the first arc band section to provide the forward and return paths.

Accordingly, in FIG. 4C, lobe 402 defines a generally clockwise path for the sense signal (e.g., for current flow) about a central axis of lobe 402. Lobe 404 defines a generally counter-clockwise path for the sense signal about a central axis of lobe 404. Lobe 406 defines a generally counter-clockwise path for the sense signal about a central axis of lobe 406. Lobe 408 defines a generally clockwise path for the sense signal about a central axis of lobe 408. More specifically, in one or more examples, first sense coil 306 of the first coil structure includes a path defined for the first sense signal to traverse (e.g., for current flow), in the following order: from the IC, to lobe 402 in a generally clockwise direction around a central axis of lobe 402; to lobe 406 in a generally counter-clockwise direction around a central axis of lobe 406; after traversing one of the connecting trace segments 430, to lobe 408 in a generally clockwise direction around a central axis of lobe 408; and to lobe 404 in a generally counter-clockwise direction around a central axis of lobe 404; and then back to the IC.

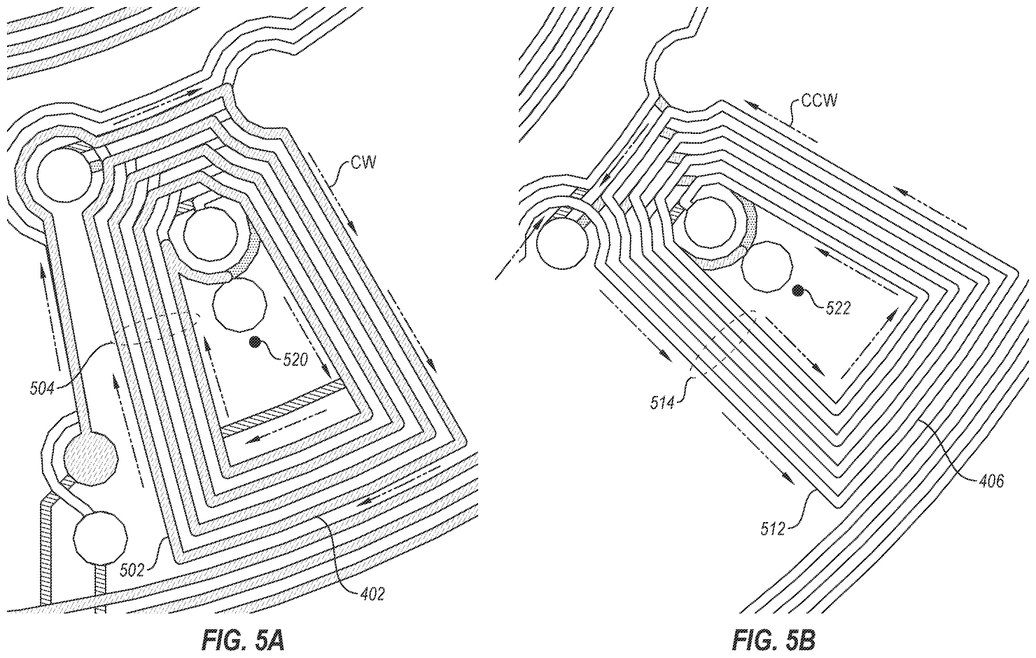

With reference ahead to FIG. 5A, lobe 402 is shown to define a generally clockwise (CW) path 502 for a sense signal (e.g., current flow) about a central axis 520 of lobe 402. In FIG. 5A, lobe 402 is shown to have multiple turns 504 in the clockwise direction about central axis 520. In one or more examples, the number of multiple turns 504 is four (4).

Note that, in one or more examples, the sense signals may oscillate, or change direction, responsive to the excitation signal changing directions. For example, responsive to the excitation signal changing directions, current may reverse directions and flow around positive sine lobes in a counter-clockwise direction and around negative sine lobes in a clockwise direction.

FIGS. 4E-4F are top down views of second sense coil 308 of the first coil structure removed and separated from both the support structure and other coil structures for illustrative clarity.

Second sense coil 308 of the first coil structure is shown to include two or more lobes 414 and 418 in the first arc band section (S1) (FIG. 4F) and two or more lobes 412 and 416 in the third arc band section (S3) (FIG. 4F). In one or more examples, a respective one of the lobes may have a generally trapezoidal or rectangular shape as shown, or any other suitable shape (e.g., a sinusoidal shape). In one or more examples, second sense coil 308 of the first coil structure is a cosine sense coil, where lobes 412 and 418 are positive cosine lobes (indicated as “COS+”) and lobes 416 and 414 are negative sine lobes (indicated as “COS−”). In one or more examples, lobes 412 and 418 that are positive cosine lobes (“COS+”) include inwardly-spiraling clockwise “CW” turns, and lobes 416 and 414 that are negative cosine lobes (“COS−”) include inwardly-spiraling counter-clockwise “CCW” turns. In addition to entry and exit trace segments to and from lobe 412 of second sense coil 308 (e.g., more fully illustrated in FIG. 4A), connecting trace segments 440 extend circumferentially to connect the lobe 416 in the third arc band section to the lobe 418 in the first arc band section to provide the forward and return paths.

As more fully illustrated in the specific, non-limiting example of FIG. 4G, lobes 414 and 418 of second sense coil 308 are arranged to alternate with lobes 404 and 408 of first sense coil 306 in a circumferential direction (e.g., CW or CCW). Similarly, lobes 412 and 416 of second sense coil 308 are arranged to alternate with lobes 402 and 406 of first sense coil 306 in a circumferential direction (e.g., CW or CCW). See again FIG. 4A depicting first coil structure 102 with the alternating sine and cosine lobes.

In one or more examples, second sense coil 308 of first coil structure 102 includes a path defined for the second sense signal to traverse (e.g., for current flow) in the same or similar manner as the path of first sense coil 306. Accordingly, in FIG. 4E, lobe 412 defines a generally clockwise path for the sense signal about a central axis of lobe 412. Lobe 414 defines a generally counter-clockwise path for the sense signal about a central axis of lobe 414. Lobe 416 defines a generally counter-clockwise path for the sense signal about a central axis of lobe 416. Lobe 418 defines a generally clockwise path for the sense signal about a central axis of lobe 418. More specifically, in one or more examples, second sense coil 308 of the first coil structure includes a path defined for the second sense signal to traverse (e.g., for current flow), in the following order: from the IC, to lobe 412 in a generally clockwise direction around a central axis of lobe 412; to lobe 416 in a generally counter-clockwise direction around a central axis of lobe 416; after traversing one of the connecting trace segments 440, to lobe 418 in a generally clockwise direction around a central axis of lobe 418; and to lobe 414 in a generally counter-clockwise direction around a central axis of lobe 414; and then back to the IC.

With reference ahead to FIG. 5B, lobe 406 is shown to define a generally counter-clockwise (CCW) path 512 for a sense signal (e.g., current flow) about a central axis 522 of lobe 406. In FIG. 5B, lobe 406 is shown to have multiple turns 514 in the counter-clockwise direction about central axis 522. In one or more examples, the number of multiple turns 514 is four (4).

Note that, in one or more examples, the sense signals may oscillate, or change direction, responsive to the excitation signal changing directions. For example, responsive to the excitation signal changing directions, current may reverse directions and flow around positive sine lobes in a counter-clockwise direction and around negative sine lobes in a clockwise direction.

Thus, various aspects of the paths associated with first and second sense coils 306 and 308 of first coil structure 102 have been shown and described in relation to FIGS. 4A-4G. Similarly, in one or more examples, the third and the fourth sense coils of the second coil structure 104 (FIG. 3B) include respective paths defined for the sense signals to traverse (e.g., for current flow), in the same or similar manner as the first and the second sense coils of the first coil structure.

With reference back to FIGS. 4C and 4D, lobe 402 is at a first position relative to axis 120 and lobe 404 is at a second position relative to axis 120. The second position of lobe 404 is substantially the same radial distance (indicated as “r” in FIG. 4D) from axis 120 as the first position of lobe 402 is from axis 120. As indicated in FIG. 4D, the second position of lobe 404 is at an angular distance Θ from the first position of lobe 402. In one or more examples, the angular distance Θ is about 180°±α/2, where α is a measurement range for angular-position sensing (e.g., α is a constant value in degrees).

In the specific, non-limiting example of FIGS. 3A and 4A-4D, the measurement range of a is 60°, and therefore the angular distance Θ is about 180°+60°/2=180°+30°=220°. In one or more examples, the angular distance Θ may be within a range of 180°±(15° to 45°). In one or more other examples, the angular distance Θ may be within a range of 180°±(24° to 36°).

More generally, the angular distance Θ may be expressed as 180°±α/2, where a is the measurement range for angular-position sensing within a range of 50% to 150% of α. Here, 180°±α/2=180°±60°/2, or within the range of 180°±50%×30° (i.e., 15°) to 180°±150%×30° (i.e., 45°)(i.e., 180°±15° to 45°). In one or more other examples, the angular distance Θ may be expressed as 180°±α/2, where α is the measurement range within a range of 75% to 125% of α. In one or more other examples, a different measurement range (e.g., less than or equal to 90°) may be utilized, as those ordinarily skilled in the art would readily appreciate. In the remaining discussion in relation to FIGS. 4C and 4D, it will be assumed that the measurement range α=60° and the angular distance Θ is about 180°+60°/2=220°.

In addition, lobe 406 is at a third position relative to axis 120 and lobe 408 is at a fourth position relative to axis 120. The fourth position of lobe 408 is substantially the same radial distance (e.g., “r”) from axis 120 as the first position of lobe 402 is from axis 120, and as the third position of lobe 406 is from axis 120. The fourth position of lobe 408 is at the angular distance Θ from the third position of lobe 406 (i.e., as measured in the opposite circumferential direction than measured between lobes 402 and 404). In the specific, non-limiting example of FIG. 4D, the angular distance Θ is again about 180°+30°=220°. In one or more examples, the angular distance Θ may be within a range of 180°±(15° to 45°).

In one or more examples, the third position of lobe 406 is at an angular distance of substantially ±30° (or substantially 30°) from the first position of lobe 402 and substantially 180° from the second position of lobe 404. In one or more examples, the fourth position of lobe 408 is at an angular distance of substantially 180° from the first position of lobe 402 and substantially ±30° (or substantially 30°) from the second position of lobe 404. In one or more examples, lobe 402 has substantially the same shape, rotated substantially 180° around axis 120, as lobe 408. Similarly, lobe 404 has substantially the same shape, rotated substantially 180° around axis 120, as lobe 406.

With reference back to FIGS. 4E and 4F, lobe 412 is at a fifth position relative to axis 120 and lobe 414 is at a sixth position relative to axis 120. The sixth position of lobe 414 is substantially the same radial distance (indicated as “r” in FIG. 4F) from axis 120 as the fifth position of lobe 412 is from axis 120. As indicated in FIG. 4F, the sixth position of lobe 414 is at an angular distance Θ from the fifth position of lobe 412. In one or more examples, the angular distance Θ is about 180°±α/2, where α is a measurement range for angular-position sensing (e.g., α is a constant value in degrees).

In the specific, non-limiting example of FIGS. 3A and 4A-4F, the measurement range of a is 60°, and therefore the angular distance Θ is about 180°+60°/2=180°+30°=220°. In one or more examples, the angular distance Θ may be within a range of 180°±(15° to 45°). In one or more other examples, the angular distance Θ may be within a range of 180°±(24° to 36°).

Again, more generally, the angular distance Θ may be expressed as 180°±α/2, where α is the measurement range for angular-position sensing within a range of 50% to 150% of α. Here, 180°±α/2=180°±60°/2 or within the range of 180°±50%×30° (i.e., 15°) to 180°±150%×30° (i.e., 45°)(i.e., 180°±15° to 45°). In one or more other examples, the angular distance Θ may be expressed as 180°±α/2, where α is the measurement range within a range of 75% to 125% of α. In one or more other examples, a different measurement range (e.g., less than or equal to 90°) may be utilized, as those ordinarily skilled in the art would readily appreciate. In the remaining discussion in relation to FIGS. 4A-4G, it will be assumed that the measurement range α=60° and the angular distance Θ is about 180°+60°/2=220°.

In addition, lobe 416 is at a seventh position relative to axis 120 and lobe 418 is at an eighth position relative to axis 120. The eighth position of lobe 418 is substantially the same radial distance (e.g., “r”) from axis 120 as the seventh position of lobe 416 is from axis 120, and as the first position of lobe 402 is from axis 120. The eighth position of lobe 418 is at the angular distance Θ from the seventh position of lobe 416 (i.e., as measured in the opposite circumferential direction than measured between lobes 412 and 414). In the specific, non-limiting example of FIG. 4F, the angular distance Θ is again about 180°+30°=220°. In one or more examples, the angular distance Θ may be within a range of 180°±(15° to 45°).

In one or more examples, the seventh position of lobe 416 is at an angular distance of substantially ±30° (or substantially 30°) from the fifth position of lobe 412 and substantially 180° from the sixth position of lobe 414. In one or more examples, the eighth position of lobe 418 is at an angular distance of substantially 180° from the fifth position of lobe 412 and substantially ±30° (or substantially 30°) from the sixth position of lobe 414. In one or more examples, lobe 412 has substantially the same shape, rotated substantially 180° around axis 120, as lobe 418. Similarly, lobe 414 has substantially the same shape, rotated substantially 180° around axis 120, as lobe 416.

With reference to FIG. 4G, in one or more examples, the fifth position of lobe 412 of second sense coil 308 is at an angular distance of substantially ±(15° to 45°)(or substantially 15° to 45°) from the first position of lobe 402 of first sense coil 306. In one or more examples, the sixth position of lobe 414 of second sense coil 308 is at the angular distance Θ from the fifth position of lobe 412 of second sense coil 308. More specifically in FIG. 4G, in one or more examples, the fifth position of lobe 412 of second sense coil 308 is at an angular distance of substantially ±15° (or substantially 15°) from the first position of lobe 402 of first sense coil 306. Here, in one or more examples, the sixth position of lobe 414 of second sense coil 308 is substantially (180°±45°)(or substantially 180°+45°) from the first position of lobe 402 of first sense coil 306.

With further reference to FIG. 4G, in one or more examples, the seventh position of lobe 416 of second sense coil 308 is at an angular distance of substantially ±45° (or substantially 45°) from the first position of lobe 402 of first sense coil 306 and substantially 180° from the sixth position of lobe 414 of second sense coil 308. Here, in one or more examples, the eighth position of lobe 418 of second sense coil 308 is substantially (180°±15°)(or substantially 180°+15°) from the first position of lobe 402 of first sense coil 306 and substantially 180° from the fifth position of lobe 412 of second sense coil 308.

Again, various aspects of the arrangement of first coil structure 102 of the first inductive angular-position sensor (“Sensor U1”) have been shown and described in relation to FIG. 3A and FIGS. 4A-4G. Likewise, with reference to FIG. 3B, second coil structure 104 of the second inductive angular-position sensor (“Sensor U2”) including third and fourth sense coils 316 and 318 may be arranged in the same or similar manner as the first coil structure having the first and the second sense coils as shown and described, except that second coil structure 104 may be arranged in the second and fourth arc band sections in a substantially symmetric, rotated, mirrored, and/or reverse-ordered configuration, as illustrated in the figures.

According to one or more examples of the disclosure, with reference to FIGS. 1A-1B, apparatus 100 may include support structure 108, target 106 to rotate about axis 120 of support structure 108, first coil structure 102 of a first inductive angular-position sensor, and second coil structure 104 of a second inductive angular-position sensor. First coil structure 102 comprises conductive traces on and/or in the one or more planes of support structure 108, and is arranged about axis 120 of rotation. Further, with reference to FIG. 3A, first coil structure 102 comprises excitation coil 302 to carry a first excitation signal. Excitation coil 302 comprises first excitation coil portion 304a and second excitation coil portion 304b. First excitation coil portion 304a is arranged around a first arc band section (e.g., S1) of the support structure. Second excitation coil portion 304b is arranged around a second arc band section (e.g., S3) of the support structure, where the second arc band section is opposite the first arc band section. First coil structure 102 also comprises first sense coil 306 and second sense coil 308. First sense coil 306 is to carry a first sense signal induced by the excitation signal. First sense coil 306 comprises two or more sine lobes arranged within first and the second excitation coil portions 304a and 304b (e.g., FIG. 4A). Second sense coil 308 is to carry a second sense signal induced by the excitation signal. Second sense coil 308 comprises two or more cosine lobes arranged within first and second excitation coil portions 304a and 304b (e.g., FIG. 4A). Further, with reference to FIG. 3B, second coil structure 104 also comprises conductive traces on and/or in the one or more planes of the support structure, and is arranged about axis 120 of rotation. Second coil structure 104 comprises excitation coil 312 to carry a second excitation signal. Excitation coil 312 comprises third excitation coil portion 314a and fourth excitation coil portion 314b. Third excitation coil portion 314a is arranged around a third arc band section (e.g., S2) of the support structure. Fourth excitation coil portion 314b is arranged around a fourth arc band section (e.g., S4) of the support structure, where the fourth arc band section is opposite the third arc band section. Third sense coil 316 is to carry a third sense signal induced by the second excitation signal. Third sense coil 316 comprises two or more sine lobes arranged within the third and the fourth excitation coil portions 314a and 314b. Fourth sense coil 318 is to carry a fourth sense signal induced by the second excitation signal. Fourth sense coil 318 comprises two or more cosine lobes arranged within third and fourth excitation coil portions 314a and 314b.

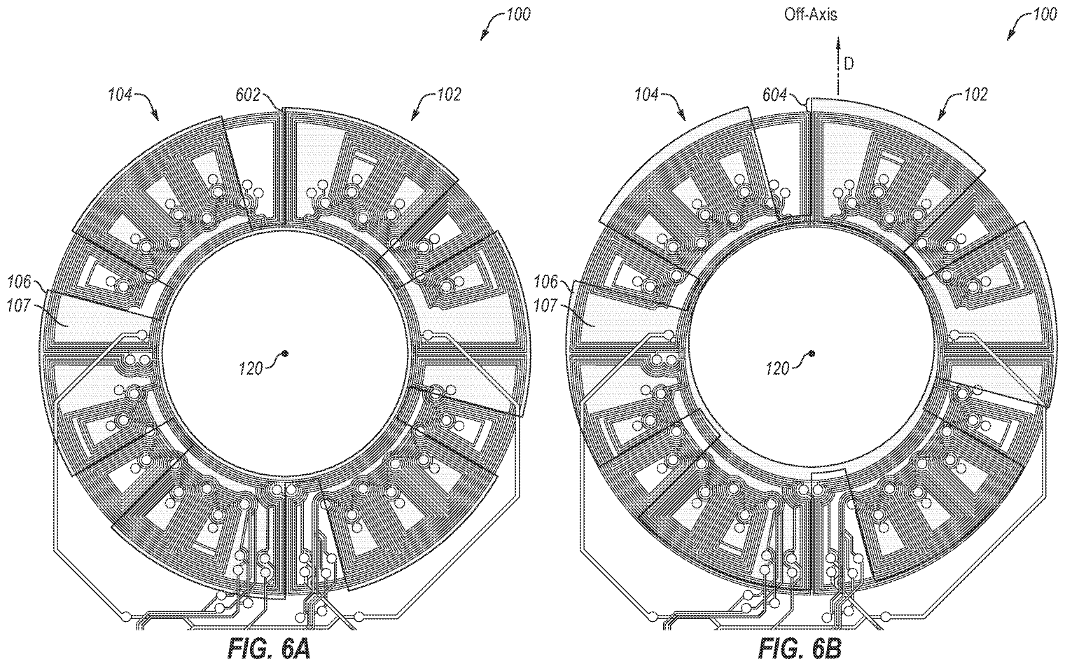

FIG. 6A is a top down view of apparatus 100 for inductive angular-position sensing of FIG. 1A according to one or more examples, where target 106 is substantially “on-axis” and/or generally centered with respect to axis 120 of rotation (e.g., detectable by an acceptable extension 602 or overhang of target 106 beyond the oscillator coil).

FIG. 6B is a top down view of apparatus 100 for inductive angular-position sensing of FIG. 6A, except that target 106 is positioned off-axis with respect to axis 120 of rotation. In FIG. 6B, target 106 may be off-axis from axis 120 by an off-axis displacement (“D”) in the direction of the y-axis (e.g., a displacement that is detectable by an (undesirable) extension 604 or overhang of target 106 beyond the oscillator coil). In one or more examples, the displacement D is about 0.8 millimeters (mm). Despite the displacement of target 106, the coverage of the lobe areas is substantially uniform, resulting in little to no phase-shift observed between the sensors. As a result, little to no phase-shift may exist between the sensor outputs, and therefore there is little to no deviation in sensor accuracy. In some conventional redundant sensors, angular-position sensing is adversely affected when the target is off-axis due to a phase-shift between sine and cosine profiles.

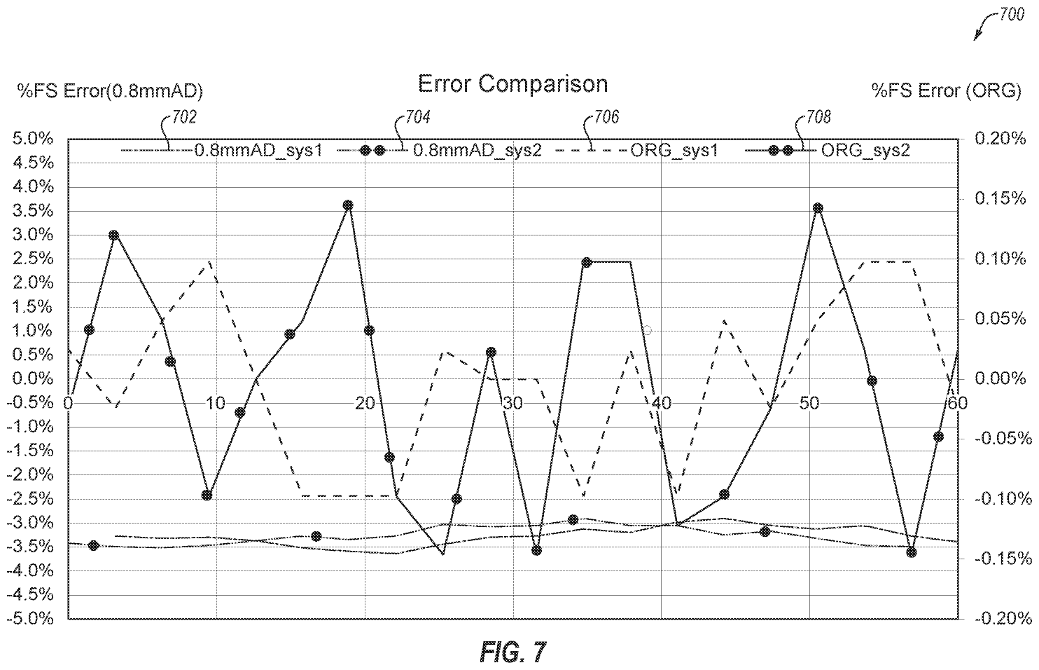

FIG. 7 is a plot diagram 700 of plots of simulation results associated with sensor accuracy of different sensor approaches having targets that are off-axis. The simulation results associated with sensor accuracy were obtained after calibration of 0.1% and 3% with the target off-axis by 0.8 mm using the same calibration parameters. A plot 706 corresponds to ORG_sys1 (e.g., sensor 1 of conventional redundant sensor) and a plot 708 corresponds to ORG_sys2 (e.g., sensor 2 of conventional redundant sensor). A plot 702 corresponds to 0.8 mmAD_sys1 (e.g., sensor 1 of redundant sensor according to one or more examples of the disclosure) and a plot 704 corresponds to 0.8 mmAD_sys2 (e.g., sensor 2 of redundant sensor according to one or more examples of the disclosure).

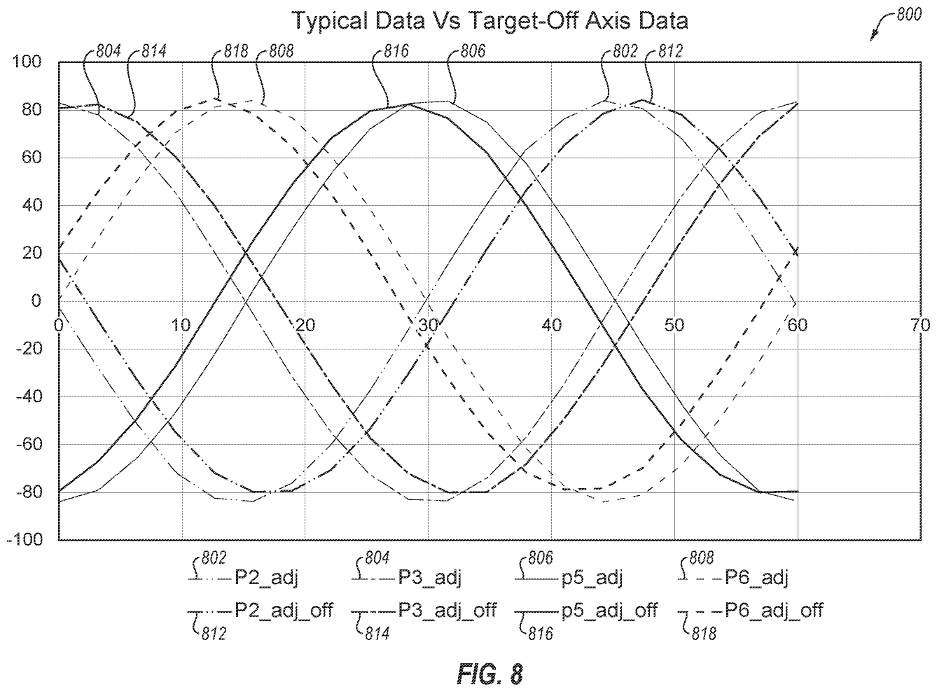

FIG. 8 is a plot diagram 800 of plots of simulation results for comparison of typical sensor data and target off-axis sensor data associated with known sensor approaches. A plot 812 corresponds to P2_adj_off (target off-axis) and a plot 802 corresponds to P2_adj; a plot 814 corresponds to P3_adj_off (target off-axis) and a plot 804 corresponds to P3_adj; a plot 816 corresponds to P5_adj_off (target off-axis) and a plot 806 corresponds to p5_adj; and a plot 818 corresponds to P6_adj_off (target off-axis) and a plot 808 corresponds to P6_adj.

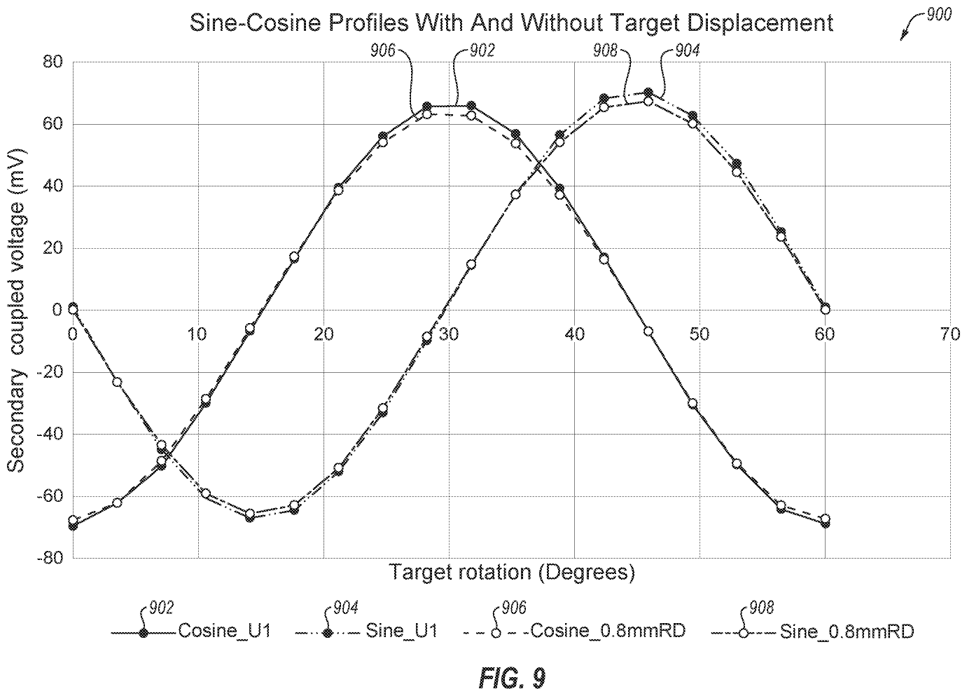

FIG. 9 is a plot diagram 900 of sine and cosine signal profiles with and without target off-axis displacement for an apparatus for inductive angular-position sensing according to one or more examples of the disclosure. In FIG. 9, a sine profile 904 is without target off-axis displacement and a sine profile 908 is with target off-axis displacement (0.8 mm); a cosine profile 902 is without target off-axis displacement and a cosine profile 906 is with target off-axis displacement (0.8 mm).

In view of the plots in FIGS. 7, 8, and 9, angular-position sensing using known sensor approaches is adversely affected when the target is off-axis due to phase-shifting between sine and cosine profiles. In one or more examples of the disclosure, sensing accuracy is not adversely affected as there is little to no phase-shift when the target is off-axis.

Thus, in one or more examples of the disclosure, angular-position sensing is provided with relatively high sensor accuracy as there is little to no phase-shift when the target is off-axis. In one or more further examples, sensor redundancy is provided with a reduced or minimal mutual coupling effect between the sensors. In yet one or more other examples, sensor redundancy is more reliable and/or less prone to failure (e.g., a single fault at the PCB component or pin level will not cause both sensors to fail).

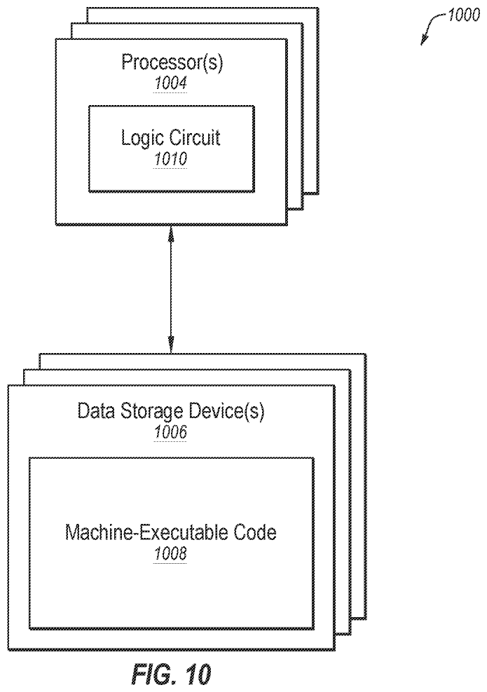

FIG. 10 is a block diagram of circuitry 1000 that, in some examples, may be used to implement various functions, operations, acts, processes, and/or methods disclosed herein. The circuitry 1000 includes one or more processors 1004 (sometimes referred to herein as “processors 1004”) operably coupled to one or more data storage devices (sometimes referred to herein as “storage 1006”). The storage 1006 includes machine-executable code 1008 stored thereon and the processors 1004 include a logic circuit 1010. The machine-executable code 1008 includes information describing functional elements that may be implemented by (e.g., performed by) the logic circuit 1010. The logic circuit 1010 is adapted to implement (e.g., perform) the functional elements described by the machine-executable code 1008. The circuitry 1000, when executing the functional elements described by the machine-executable code 1008, should be considered as special purpose hardware for carrying out functional elements disclosed herein. In some examples, the processors 1004 may perform the functional elements described by the machine-executable code 1008 sequentially, concurrently (e.g., on one or more different hardware platforms), or in one or more parallel process streams.

When implemented by logic circuit 1010 of the processors 1004, the machine-executable code 1008 adapts the processors 1004 to perform operations of examples disclosed herein. For example, the machine-executable code 1008 may be to adapt the processors 1004 to perform at least a portion or a totality of operations associated with the apparatus 100 for inductive angular-position sensing according to one or more examples, including a method of generating an output signal indicative of an angular-position of a target; a method of generating a first output signal (e.g., the first sense signal demodulated) based on a first sense signal and a second output signal (e.g., the second sense signal demodulated) based on a second sense signal; and/or a method of generating a single output signal (e.g., a constant-slope output signal) based on the first sense signal and the second sense signal, responsive to rotation of a target.

The processors 1004 may include a general purpose processor, a special purpose processor, a central processing unit (CPU), a microcontroller, a programmable logic controller (PLC), a digital signal processor (DSP), an application specific integrated circuit (ASIC), a field-programmable gate array (FPGA) or other programmable logic device, discrete gate or transistor logic, discrete hardware components, other programmable device, or any combination thereof designed to perform the functions disclosed herein. A general-purpose computer including a processor is considered a special-purpose computer while the general-purpose computer executes functional elements corresponding to the machine-executable code 1008 (e.g., software code, firmware code, hardware descriptions) related to examples of the present disclosure. It is noted that a general-purpose processor (may also be referred to herein as a host processor or simply a host) may be a microprocessor, but in the alternative, the processors 1004 may include any conventional processor, controller, microcontroller, or state machine. The processors 1004 may also be implemented as a combination of computing devices, such as a combination of a DSP and a microprocessor, a plurality of microprocessors, one or more microprocessors in conjunction with a DSP core, or any other such configuration.

In some examples the storage 1006 includes volatile data storage (e.g., random-access memory (RAM)), non-volatile data storage (e.g., Flash memory, a hard disc drive, a solid state drive, erasable programmable read-only memory (EPROM), etc.). In some examples the processors 1004 and the storage 1006 may be implemented into a single device (e.g., a semiconductor device product, a system on chip (SOC), etc.). In some examples the processors 1004 and the storage 1006 may be implemented into separate devices.

In some examples the machine-executable code 1008 may include computer-readable instructions (e.g., software code, firmware code). By way of non-limiting example, the computer-readable instructions may be stored by the storage 1006, accessed directly by the processors 1004, and executed by the processors 1004 using at least the logic circuit 1010. Also by way of non-limiting example, the computer-readable instructions may be stored on the storage 1006, transferred to a memory device (not shown) for execution, and executed by the processors 1004 using at least the logic circuit 1010. Accordingly, in some examples the logic circuit 1010 includes electrically configurable logic circuit 1010.

In some examples the machine-executable code 1008 may describe hardware (e.g., circuitry) to be implemented in the logic circuit 1010 to perform the functional elements. This hardware may be described at any of a variety of levels of abstraction, from low-level transistor layouts to high-level description languages. At a high-level of abstraction, a hardware description language (HDL) such as an IEEE Standard hardware description language (HDL) may be used. By way of non-limiting examples, VERILOG™, SYSTEMVERILOG™ or very large scale integration (VLSI) hardware description language (VHDL™) may be used.

HDL descriptions may be converted into descriptions at any of numerous other levels of abstraction as desired. As a non-limiting example, a high-level description can be converted to a logic-level description such as a register-transfer language (RTL), a gate-level (GL) description, a layout-level description, or a mask-level description. As a non-limiting example, micro-operations to be performed by hardware logic circuits (e.g., gates, flip-flops, registers, without limitation) of the logic circuit 1010 may be described in a RTL and then converted by a synthesis tool into a GL description, and the GL description may be converted by a placement and routing tool into a layout-level description that corresponds to a physical layout of an integrated circuit of a programmable logic device, discrete gate or transistor logic, discrete hardware components, or combinations thereof. Accordingly, in some examples the machine-executable code 1008 may include an HDL, an RTL, a GL description, a mask level description, other hardware description, or any combination thereof.

In examples where the machine-executable code 1008 includes a hardware description (at any level of abstraction), a system (not shown, but including the storage 1006) may be to implement the hardware description described by the machine-executable code 1008. By way of non-limiting example, the processors 1004 may include a programmable logic device (e.g., an FPGA or a PLC) and the logic circuit 1010 may be electrically controlled to implement circuitry corresponding to the hardware description into the logic circuit 1010. Also by way of non-limiting example, the logic circuit 1010 may include hard-wired logic manufactured by a manufacturing system (not shown, but including the storage 1006) according to the hardware description of the machine-executable code 1008.

Regardless of whether the machine-executable code 1008 includes computer-readable instructions or a hardware description, the logic circuit 1010 is adapted to perform the functional elements described by the machine-executable code 1008 when implementing the functional elements of the machine-executable code 1008. It is noted that although a hardware description may not directly describe functional elements, a hardware description indirectly describes functional elements that the hardware elements described by the hardware description are capable of performing.

As used in the present disclosure, references to things (including oscillator coils, sense coils, and paths, without limitation) being “at,” “in,” “on,” “arranged at,” “arranged in,” “arranged on” and like terms a support structure may refer to the things being arranged substantially within and/or on a surface of the support structure.

In addition, the term “substantially” in reference to a given parameter, property, or condition means and includes to a degree that one skilled in the art would understand that the given parameter, property, or condition is met with a small degree of variance, such as within acceptable manufacturing tolerances. For example, a parameter that is substantially met may be at least about 90% met, at least about 95% met, or even at least about 99% met.

Further, the terms “module” or “component” may refer to specific hardware implementations to perform the actions of the module or component and/or software objects or software routines that may be stored on and/or executed by general purpose hardware (e.g., computer-readable media, processing devices, etc.) of the computing system. In some examples, the different components, modules, engines, and services described in the present disclosure may be implemented as objects or processes that execute on the computing system (e.g., as separate threads). While some of the system and methods described in the present disclosure are generally described as being implemented in software (stored on and/or executed by general purpose hardware), specific hardware implementations or a combination of software and specific hardware implementations are also possible and contemplated.

As used in the present disclosure, the term “combination” with reference to a plurality of elements may include a combination of all the elements or any of various different subcombinations of some of the elements. For example, the phrase “A, B, C, D, or combinations thereof” may refer to any one of A, B, C, or D; the combination of each of A, B, C, and D; and any subcombination of A, B, C, or D such as A, B, and C; A, B, and D; A, C, and D; B, C, and D; A and B; A and C; A and D; B and C; B and D; or C and D.

Terms used in the present disclosure and especially in the appended claims (e.g., bodies of the appended claims) are generally intended as “open” terms (e.g., the term “including” should be interpreted as “including, but not limited to,” the term “having” should be interpreted as “having at least,” the term “includes” should be interpreted as “includes, but is not limited to,” etc.).

Additionally, if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to examples containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations.

In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.,” or “one or more of A, B, and C, etc.,” is used, in general such a construction is intended to include A alone, B alone, C alone, A and B together, A and C together, B and C together, or A, B, and C together, etc.

Any disjunctive word or phrase presenting two or more alternative terms, whether in the description, claims, or drawings, should be understood to contemplate the possibilities of including one of the terms, either of the terms, or both terms. For example, the phrase “A or B” should be understood to include the possibilities of “A” or “B” or “A and B.”

Additional non-limiting examples of the disclosure include:

Example 1: An apparatus comprising: a target to rotate about an axis; an excitation coil to carry an excitation signal; and a first sense coil to carry a sense signal induced by the excitation signal, the first sense coil comprising two or more lobes in one or more planes that are perpendicular to the axis, the two or more lobes comprising: a first lobe at a first position relative to the axis; and a second lobe at a second position relative to the axis, the second position substantially the same radial distance from the axis as the first position is from the axis, the second position at an angular distance of Θ from the first position, where Θ=180°±α/2, and α is a measurement range for angular-position sensing within a range of 50% to 150% of α.

Example 2: The apparatus according to Example 1, wherein: the first lobe defines a generally clockwise path for the sense signal about a central axis of the first lobe; and the second lobe defines a generally counter-clockwise path for the sense signal about a central axis of the second lobe.

Example 3: The apparatus according to Examples 1 and 2, wherein the excitation coil comprises a first excitation coil comprising: a first excitation coil portion arranged to substantially surround the first lobe of the first sense coil; a second excitation coil portion arranged to substantially surround the second lobe of the first sense coil; and a center tap coupling between the first excitation coil portion and the second excitation coil portion to supply an excitation voltage signal to the first excitation coil portion and the second excitation coil portion.

Example 4: The apparatus according to any of Examples 1 to 3, wherein: the first excitation coil portion and the first lobe of the first sense coil are located within a first quadrant defined by two perpendicular lines, crossing at the axis, in a plane of the one or more planes; and the second excitation coil portion and the second lobe of the first sense coil are located within a third quadrant defined by the two perpendicular lines, the third quadrant opposite the first quadrant.

Example 5: The apparatus according to any of Examples 1 to 4, wherein respective ones of the first excitation coil portion and the second excitation coil portion comprises: an inner-circumferential portion defining a respective arc of a first circle centered at the axis; an outer-circumferential portion defining a respective arc of a second circle centered at the axis, the second circle larger than the first circle; and radial portions between respective ends of the inner-circumferential portion and the outer-circumferential portion.

Example 6: The apparatus according to any of Examples 1 to 5, wherein the sense signal comprises a first sense signal, and α=60°, the apparatus comprising: a second sense coil to carry a second sense signal induced by the excitation signal, the second sense coil comprising two or more respective lobes in the one or more planes, the two or more respective lobes comprising: a first respective lobe at a third position relative to the axis, the third position substantially the same radial distance from the axis as the first position is from the axis, the third position at an angular distance within a range of ±(15° to 45°) from the first position; and a second respective lobe at a fourth position relative to the axis, the fourth position substantially the same radial distance from the axis as the first position is from the axis, the fourth position at the angular distance Θ from the third position.

Example 7: The apparatus according to any of Examples 1 to 6, wherein α=60°, and the two or more lobes of the first sense coil comprise: a third lobe at a third position relative to the axis, the third position being substantially the same radial distance from the axis as the first position is from the axis, the third position at an angular distance of substantially ±30° from the first position and substantially 180° from the second position; and a fourth lobe at a fourth position relative to the axis, the fourth position being substantially the same radial distance from the axis as the first position is from the axis, the fourth position at an angular distance of substantially 180° from the first position and substantially ±30° from the second position.

Example 8: The apparatus according to any of Examples 1 to 7, wherein: the first lobe defines a respective generally clockwise path for the sense signal about a central axis of the first lobe; the second lobe defines a respective generally counter-clockwise path for the sense signal about a central axis of the second lobe; the third lobe defines a respective generally counter-clockwise path for the sense signal about a central axis of the third lobe; and the fourth lobe defines a respective generally clockwise path for the sense signal about a central axis of the fourth lobe.

Example 9: The apparatus according to any of Examples 1 to 8, wherein a path defined for the sense signal to traverse, in order: the first lobe in a generally clockwise direction around a central axis of the first lobe; the third lobe in a generally counter-clockwise direction around a central axis of the third lobe; the fourth lobe in a generally clockwise direction around a central axis of the fourth lobe; and the second lobe in a generally counter-clockwise direction around a central axis of the second lobe.

Example 10: The apparatus according to any of Examples 1 to 9, wherein: the first lobe has substantially the same shape, rotated substantially 180° around the axis, as the fourth lobe, and the second lobe has substantially the same shape, rotated substantially 180° around the axis, as the third lobe.

Example 11: The apparatus according to any of Examples 1 to 10, wherein the excitation coil comprises a first excitation coil comprising: a first excitation coil portion arranged to substantially surround the first lobe of the first sense coil and the third lobe of the first sense coil; and a second excitation coil portion arranged to substantially surround the second lobe of the first sense coil and the fourth lobe of the first sense coil.

Example 12: The apparatus according to any of Examples 1 to 11, wherein: the first excitation coil portion, the first lobe of the first sense coil, and the third lobe of the first sense coil are located within a first quadrant defined by two perpendicular lines, crossing at the axis, in a plane of the one or more planes; and the second excitation coil portion, the second lobe of the first sense coil, and the fourth lobe of the first sense coil are located within a third quadrant defined by the two perpendicular lines, the third quadrant adjacent the first quadrant.

Example 13: The apparatus according to any of Examples 1 to 12, wherein the first excitation coil portion comprises: an inner-circumferential portion defining a respective arc of a first circle centered at the axis; an outer-circumferential portion defining a respective arc of a second circle centered at the axis, the second circle larger than the first circle; and radial portions between respective ends of the inner-circumferential portion and the outer-circumferential portion.

Example 14: The apparatus according to any of Examples 1 to 13, wherein the sense signal comprises a first sense signal, and α=60°, the apparatus comprising: a second sense coil to carry a second sense signal induced by the excitation signal, the second sense coil comprising two or more respective lobes in the one or more planes, the two or more respective lobes comprising: a first respective lobe at a fifth position relative to the axis, the fifth position substantially the same radial distance from the axis as the first position is from the axis, the fifth position at an angular distance of substantially ±15° from the first position; and a second respective lobe at a sixth position relative to the axis, the sixth position substantially the same radial distance from the axis as the first position is from the axis, the sixth position at an angular distance of substantially 180°±45° from the first position.

Example 15: The apparatus according to any of Examples 1 to 14, wherein α=60°, and the two or more respective lobes of the second sense coil comprise: a third respective lobe at a seventh position relative to the axis, the seventh position being substantially the same radial distance from the axis as the first position is from the axis, the seventh position at an angular distance of substantially ±45° from the first position and substantially 180° from the sixth position; and a fourth respective lobe at an eighth position relative to the axis, the eighth position being substantially the same radial distance from the axis as the first position is from the axis, the eighth position an angular distance of substantially 180°±15° from the first position and substantially 180° from the fifth position.

Example 16: The apparatus according to any of Examples 1 to 15, wherein the target comprises: multiple fins, evenly radially spaced around the axis, the multiple fins defining gaps between respective fins, a respective one of the gaps substantially the same size, measured circumferentially around the axis, as the first lobe.

Example 17: The apparatus according to any of Examples 1 to 16, wherein the apparatus comprises a first inductive angular-position sensor comprising the target, the excitation coil, and the first sense coil, the apparatus comprising: a second inductive angular-position sensor comprising: a respective excitation coil to carry a respective excitation signal; a respective first sense coil to carry a respective sense signal induced by the respective excitation signal, the respective first sense coil comprising two or more respective lobes in the one or more planes, the two or more respective lobes comprising: a first respective lobe at a third position relative to the axis, the third position substantially the same radial distance from the axis as the first position is from the axis, the third position at an angular distance of substantially 30° from the first position; and a second respective lobe at a fourth position relative to the axis, the fourth position substantially the same radial distance from the axis as the first position is from the axis, the fourth position at the angular distance Θ from the third position.

Example 18: The apparatus according to any of Examples 1 to 17, wherein: the excitation coil of the first inductive angular-position sensor comprises: a first respective excitation coil arranged to substantially surround the first lobe of the first inductive angular-position sensor; and a second respective excitation coil arranged to substantially surround the second lobe of the first inductive angular-position sensor; and the respective excitation coil of the second inductive angular-position sensor comprises: a first respective excitation coil arranged to substantially surround the first respective lobe of the second inductive angular-position sensor; and a second respective excitation coil arranged to substantially surround the second respective lobe of the second inductive angular-position sensor.

Example 19: The apparatus according to any of Examples 1 to 18, wherein: the first respective excitation coil of the first inductive angular-position sensor and the first lobe of the first sense coil of the first inductive angular-position sensor are located within a first quadrant defined by two perpendicular lines, crossing at the axis, in a plane of the one or more planes; the second respective excitation coil of the first inductive angular-position sensor and the second lobe of the first sense coil of the first inductive angular-position sensor are located within a third quadrant defined by the two perpendicular lines, the third quadrant adjacent the first quadrant; the first respective excitation coil of the second inductive angular-position sensor and the first respective lobe of the first respective sense coil of the second inductive angular-position sensor are located within a second quadrant defined by the two perpendicular lines, the second quadrant adjacent the first quadrant and the third quadrant; and the second respective excitation coil of the second inductive angular-position sensor and the second respective lobe of the first respective sense coil of the second inductive angular-position sensor are located within a fourth quadrant defined by the two perpendicular lines, the fourth quadrant opposite the second quadrant.

Example 20: The apparatus according to any of Examples 1 to 19, wherein α=60°.

Example 21: An apparatus comprising: a support structure; a coil structure for an inductive angular-position sensor, the coil structure comprising conductive traces on and/or in one or more planes of the support structure, the coil structure arranged about an axis of rotation for a target, the coil structure comprising: an excitation coil to carry an excitation signal, the excitation coil comprising a first excitation coil portion and a second excitation coil portion, the first excitation coil portion arranged around a first arc band section of the support structure, the second excitation coil portion arranged around a second arc band section of the support structure, the second arc band section opposite the first arc band section; a first sense coil to carry a first sense signal induced by the excitation signal, the first sense coil comprising two or more first lobes arranged within the first and the second excitation coil portions; and a second sense coil to carry a second sense signal induced by the excitation signal, the second sense coil comprising two or more second lobes arranged within the first and the second excitation coil portions.

Example 22: The apparatus according to Example 21, wherein: the two or more first lobes of the first sense coil comprise: a first lobe at a first position relative to the axis; and a second lobe at a second position relative to the axis, the second position substantially the same radial distance from the axis as the first position is from the axis, the second position at an angular distance Θ from the first position, where Θ=180°±α/2, and α is a measurement range for angular-position sensing.

Example 23: The apparatus according to Examples 21 and 22, wherein α=60°, and wherein: the two or more first lobes of the first sense coil comprise: a third lobe at a third position relative to the axis, the third position substantially the same radial distance from the axis as the first position is from the axis, the third position at an angular distance of substantially 30° from the first position; and a fourth lobe at a fourth position relative to the axis, the fourth position substantially the same radial distance from the axis as the first position is from the axis, the second position at an angular distance of substantially 180° from the first position and the angular distance Θ from the third position.

Example 24: The apparatus according to any of Examples 21 to 23, wherein the coil structure comprises a first coil structure, the inductive angular-position sensor comprises a first inductive angular-position sensor, the excitation coil comprises a first excitation coil, and the excitation signal comprises a first excitation signal, the apparatus comprising: a second coil structure for a second inductive angular-position sensor, the second coil structure comprising conductive traces on and/or in the one or more planes of the support structure, the second coil structure arranged about the axis of rotation, the second coil structure comprising: a second excitation coil to carry a second excitation signal, the second excitation coil comprising a third excitation coil portion and a fourth excitation coil portion, the third excitation coil portion arranged around a third arc band section of the support structure, the fourth excitation coil portion arranged around a fourth arc band section of the support structure, the fourth arc band section opposite the third arc band section; a third sense coil to carry a third sense signal induced by the second excitation signal, the third sense coil comprising two or more third lobes arranged within the third and the fourth excitation coil portions; and a fourth sense coil to carry a fourth sense signal induced by the second excitation signal, the fourth sense coil comprising two or more fourth lobes arranged within the third and the fourth excitation coil portions.

Example 25: The apparatus according to any of Examples 21 to 24, wherein: the two or more first lobes of the first sense coil comprise at least two sine lobes, the two or more second lobes of the second sense coil comprise at least two cosine lobes, the two or more third lobes of the third sense coil comprise at least two sine lobes, and the two or more fourth lobes of the fourth sense coil comprise at least two cosine lobes.

Example 26: An apparatus comprising: a support structure; a target to rotate about an axis of the support structure; a first coil structure of a first inductive angular-position sensor, the first coil structure comprising conductive traces on and/or in one or more planes of the support structure, the first coil structure arranged about the axis of rotation, the first coil structure comprising: a first excitation coil to carry a first excitation signal, the first excitation coil comprising a first excitation coil portion and a second excitation coil portion, the first excitation coil portion arranged around a first arc band section of the support structure, the second excitation coil portion arranged around a second arc band section of the support structure, the second arc band section opposite the first arc band section; a first sense coil to carry a first sense signal induced by the excitation signal, the first sense coil comprising two or more sine lobes arranged within the first and the second excitation coil portions; a second sense coil to carry a second sense signal induced by the excitation signal, the second sense coil comprising two or more cosine lobes arranged within the first and the second excitation coil portions; a second coil structure of a second inductive angular-position sensor, the second coil structure comprising conductive traces on and/or in the one or more planes of the support structure, the second coil structure arranged about the axis of rotation, the second coil structure comprising: a second excitation coil to carry a second excitation signal, the second excitation coil comprising a third excitation coil portion and a fourth excitation coil portion, the third excitation coil portion arranged around a third arc band section of the support structure, the fourth excitation coil portion arranged around a fourth arc band section of the support structure, the fourth arc band section opposite the third arc band section; a third sense coil to carry a third sense signal induced by the second excitation signal, the third sense coil comprising two or more sine lobes arranged within the third and the fourth excitation coil portions; and a fourth sense coil to carry a fourth sense signal induced by the second excitation signal, the fourth sense coil comprising two or more cosine lobes arranged within the third and the fourth excitation coil portion.

While the present disclosure has been described herein with respect to certain illustrated examples, those of ordinary skill in the art will recognize and appreciate that the present invention is not so limited. Rather, many additions, deletions, and modifications to the illustrated and described examples may be made without departing from the scope of the invention as hereinafter claimed along with their legal equivalents. In addition, features from one example may be combined with features of another example while still being encompassed within the scope of the invention as contemplated by the inventor.

What is claimed is:

1. An apparatus comprising:
a target to rotate about an axis;
an excitation coil to carry an excitation signal; and
a first sense coil to carry a sense signal induced by the excitation signal, the first sense coil comprising two or more lobes in one or more planes that are perpendicular to the axis, the two or more lobes comprising:
a first lobe at a first position relative to the axis; and
a second lobe at a second position relative to the axis, the second position substantially the same radial distance from the axis as the first position is from the axis, the second position at an angular distance of Θ from the first position,
where Θ=180°±α/2, and α is a measurement range for angular-position sensing within a range of 50% to 150% of α.

2. The apparatus of claim 1, wherein:
the first lobe defines a generally clockwise path for the sense signal about a central axis of the first lobe; and
the second lobe defines a generally counter-clockwise path for the sense signal about a central axis of the second lobe.

3. The apparatus of claim 1, wherein the excitation coil comprises a first excitation coil comprising:
a first excitation coil portion arranged to substantially surround the first lobe of the first sense coil;
a second excitation coil portion arranged to substantially surround the second lobe of the first sense coil; and
a center tap coupling between the first excitation coil portion and the second excitation coil portion to supply an excitation voltage signal to the first excitation coil portion and the second excitation coil portion.

4. The apparatus of claim 3, wherein:
the first excitation coil portion and the first lobe of the first sense coil are located within a first quadrant defined by two perpendicular lines, crossing at the axis, in a plane of the one or more planes; and
the second excitation coil portion and the second lobe of the first sense coil are located within a third quadrant defined by the two perpendicular lines, the third quadrant opposite the first quadrant.

5. The apparatus of claim 3, wherein respective ones of the first excitation coil portion and the second excitation coil portion comprises:
an inner-circumferential portion defining a respective arc of a first circle centered at the axis;
an outer-circumferential portion defining a respective arc of a second circle centered at the axis, the second circle larger than the first circle; and
radial portions between respective ends of the inner-circumferential portion and the outer-circumferential portion.

6. The apparatus of claim 1, wherein the sense signal comprises a first sense signal, and α=60°, the apparatus comprising:
a second sense coil to carry a second sense signal induced by the excitation signal, the second sense coil comprising two or more respective lobes in the one or more planes, the two or more respective lobes comprising:
a first respective lobe at a third position relative to the axis, the third position substantially the same radial distance from the axis as the first position is from the axis, the third position at an angular distance within a range of ±(15° to 45°) from the first position; and
a second respective lobe at a fourth position relative to the axis, the fourth position substantially the same radial distance from the axis as the first position is from the axis, the fourth position at the angular distance Θ from the third position.

7. The apparatus of claim 1, wherein α=60°, and the two or more lobes of the first sense coil comprise:
a third lobe at a third position relative to the axis, the third position being substantially the same radial distance from the axis as the first position is from the axis, the third position at an angular distance of substantially ±30° from the first position and substantially 180° from the second position; and
a fourth lobe at a fourth position relative to the axis, the fourth position being substantially the same radial distance from the axis as the first position is from the axis, the fourth position at an angular distance of substantially 180° from the first position and substantially ±30° from the second position.

8. The apparatus of claim 7, wherein:
the first lobe defines a respective generally clockwise path for the sense signal about a central axis of the first lobe;
the second lobe defines a respective generally counter-clockwise path for the sense signal about a central axis of the second lobe;
the third lobe defines a respective generally counter-clockwise path for the sense signal about a central axis of the third lobe; and
the fourth lobe defines a respective generally clockwise path for the sense signal about a central axis of the fourth lobe.

9. The apparatus of claim 7, wherein a path defined for the sense signal to traverse, in order:
the first lobe in a generally clockwise direction around a central axis of the first lobe;
the third lobe in a generally counter-clockwise direction around a central axis of the third lobe;
the fourth lobe in a generally clockwise direction around a central axis of the fourth lobe; and
the second lobe in a generally counter-clockwise direction around a central axis of the second lobe.

10. The apparatus of claim 7, wherein:
the first lobe has substantially the same shape, rotated substantially 180° around the axis, as the fourth lobe, and
the second lobe has substantially the same shape, rotated substantially 180° around the axis, as the third lobe.

11. The apparatus of claim 7, wherein the excitation coil comprises a first excitation coil comprising:
a first excitation coil portion arranged to substantially surround the first lobe of the first sense coil and the third lobe of the first sense coil; and
a second excitation coil portion arranged to substantially surround the second lobe of the first sense coil and the fourth lobe of the first sense coil.

12. The apparatus of claim 11, wherein:
the first excitation coil portion, the first lobe of the first sense coil, and the third lobe of the first sense coil are located within a first quadrant defined by two perpendicular lines, crossing at the axis, in a plane of the one or more planes; and
the second excitation coil portion, the second lobe of the first sense coil, and the fourth lobe of the first sense coil are located within a third quadrant defined by the two perpendicular lines, the third quadrant adjacent the first quadrant.

13. The apparatus of claim 11, wherein the first excitation coil portion comprises:
an inner-circumferential portion defining a respective arc of a first circle centered at the axis;
an outer-circumferential portion defining a respective arc of a second circle centered at the axis, the second circle larger than the first circle; and
radial portions between respective ends of the inner-circumferential portion and the outer-circumferential portion.

14. The apparatus of claim 7, wherein the sense signal comprises a first sense signal, and α=60°, the apparatus comprising:
a second sense coil to carry a second sense signal induced by the excitation signal, the second sense coil comprising two or more respective lobes in the one or more planes, the two or more respective lobes comprising:
a first respective lobe at a fifth position relative to the axis, the fifth position substantially the same radial distance from the axis as the first position is from the axis, the fifth position at an angular distance of substantially ±15° from the first position; and
a second respective lobe at a sixth position relative to the axis, the sixth position substantially the same radial distance from the axis as the first position is from the axis, the sixth position at an angular distance of substantially 180°±45° from the first position.

15. The apparatus of claim 14, wherein α=60°, and the two or more respective lobes of the second sense coil comprise:
a third respective lobe at a seventh position relative to the axis, the seventh position being substantially the same radial distance from the axis as the first position is from the axis, the seventh position at an angular distance of substantially ±45° from the first position and substantially 180° from the sixth position; and
a fourth respective lobe at an eighth position relative to the axis, the eighth position being substantially the same radial distance from the axis as the first position is from the axis, the eighth position an angular distance of substantially 180°±15° from the first position and substantially 180° from the fifth position.

16. The apparatus of claim 1, wherein the target comprises:
multiple fins, evenly radially spaced around the axis, the multiple fins defining gaps between respective fins, a respective one of the gaps substantially the same size, measured circumferentially around the axis, as the first lobe.

17. The apparatus of claim 1, wherein the apparatus comprises a first inductive angular-position sensor comprising the target, the excitation coil, and the first sense coil, the apparatus comprising:
a second inductive angular-position sensor comprising:
a respective excitation coil to carry a respective excitation signal;
a respective first sense coil to carry a respective sense signal induced by the respective excitation signal, the respective first sense coil comprising two or more respective lobes in the one or more planes, the two or more respective lobes comprising:
a first respective lobe at a third position relative to the axis, the third position substantially the same radial distance from the axis as the first position is from the axis, the third position at an angular distance of substantially 30° from the first position; and
a second respective lobe at a fourth position relative to the axis, the fourth position substantially the same radial distance from the axis as the first position is from the axis, the fourth position at the angular distance Θ from the third position.

18. The apparatus of claim 17, wherein:
the excitation coil of the first inductive angular-position sensor comprises:
a first respective excitation coil arranged to substantially surround the first lobe of the first inductive angular-position sensor; and
a second respective excitation coil arranged to substantially surround the second lobe of the first inductive angular-position sensor; and
the respective excitation coil of the second inductive angular-position sensor comprises:
a first respective excitation coil arranged to substantially surround the first respective lobe of the second inductive angular-position sensor; and
a second respective excitation coil arranged to substantially surround the second respective lobe of the second inductive angular-position sensor.

19. The apparatus of claim 18, wherein:
the first respective excitation coil of the first inductive angular-position sensor and the first lobe of the first sense coil of the first inductive angular-position sensor are located within a first quadrant defined by two perpendicular lines, crossing at the axis, in a plane of the one or more planes;
the second respective excitation coil of the first inductive angular-position sensor and the second lobe of the first sense coil of the first inductive angular-position sensor are located within a third quadrant defined by the two perpendicular lines, the third quadrant adjacent the first quadrant;
the first respective excitation coil of the second inductive angular-position sensor and the first respective lobe of the first respective sense coil of the second inductive angular-position sensor are located within a second quadrant defined by the two perpendicular lines, the second quadrant adjacent the first quadrant and the third quadrant; and
the second respective excitation coil of the second inductive angular-position sensor and the second respective lobe of the first respective sense coil of the second inductive angular-position sensor are located within a fourth quadrant defined by the two perpendicular lines, the fourth quadrant opposite the second quadrant.

20. The apparatus of claim 1, wherein α=60°.

21. An apparatus comprising:
a support structure;
a coil structure for an inductive angular-position sensor, the coil structure comprising conductive traces on and/or in one or more planes of the support structure, the coil structure arranged about an axis of rotation for a target, the coil structure comprising:
an excitation coil to carry an excitation signal, the excitation coil comprising a first excitation coil portion and a second excitation coil portion, the first excitation coil portion arranged around a first arc band section of the support structure, the second excitation coil portion arranged around a second arc band section of the support structure, the second arc band section opposite the first arc band section;
a first sense coil to carry a first sense signal induced by the excitation signal, the first sense coil comprising two or more first lobes arranged within the first and the second excitation coil portions; and
a second sense coil to carry a second sense signal induced by the excitation signal, the second sense coil comprising two or more second lobes arranged within the first and the second excitation coil portions.

22. The apparatus of claim 21, wherein:
the two or more first lobes of the first sense coil comprise:
a first lobe at a first position relative to the axis; and
a second lobe at a second position relative to the axis, the second position substantially the same radial distance from the axis as the first position is from the axis, the second position at an angular distance Θ from the first position, where Θ=180°±α/2, and α is a measurement range for angular-position sensing.

23. The apparatus of claim 22, wherein α=60°, and wherein:
the two or more first lobes of the first sense coil comprise:
a third lobe at a third position relative to the axis, the third position substantially the same radial distance from the axis as the first position is from the axis, the third position at an angular distance of substantially 30° from the first position; and
a fourth lobe at a fourth position relative to the axis, the fourth position substantially the same radial distance from the axis as the first position is from the axis, the second position at an angular distance of substantially 180° from the first position and the angular distance Θ from the third position.

24. The apparatus of claim 21, wherein the coil structure comprises a first coil structure, the inductive angular-position sensor comprises a first inductive angular-position sensor, the excitation coil comprises a first excitation coil, and the excitation signal comprises a first excitation signal, the apparatus comprising:
a second coil structure for a second inductive angular-position sensor, the second coil structure comprising conductive traces on and/or in the one or more planes of the support structure, the second coil structure arranged about the axis of rotation, the second coil structure comprising:
a second excitation coil to carry a second excitation signal, the second excitation coil comprising a third excitation coil portion and a fourth excitation coil portion, the third excitation coil portion arranged around a third arc band section of the support structure, the fourth excitation coil portion arranged around a fourth arc band section of the support structure, the fourth arc band section opposite the third arc band section;
a third sense coil to carry a third sense signal induced by the second excitation signal, the third sense coil comprising two or more third lobes arranged within the third and the fourth excitation coil portions; and
a fourth sense coil to carry a fourth sense signal induced by the second excitation signal, the fourth sense coil comprising two or more fourth lobes arranged within the third and the fourth excitation coil portions.

25. The apparatus of claim 24, wherein:
the two or more first lobes of the first sense coil comprise at least two sine lobes,
the two or more second lobes of the second sense coil comprise at least two cosine lobes,
the two or more third lobes of the third sense coil comprise at least two sine lobes, and
the two or more fourth lobes of the fourth sense coil comprise at least two cosine lobes.

26. An apparatus comprising:
a support structure;
a target to rotate about an axis of the support structure;
a first coil structure of a first inductive angular-position sensor, the first coil structure comprising conductive traces on and/or in one or more planes of the support structure, the first coil structure arranged about the axis of rotation, the first coil structure comprising:
a first excitation coil to carry a first excitation signal, the first excitation coil comprising a first excitation coil portion and a second excitation coil portion, the first excitation coil portion arranged around a first arc band section of the support structure, the second excitation coil portion arranged around a second arc band section of the support structure, the second arc band section opposite the first arc band section;
a first sense coil to carry a first sense signal induced by the excitation signal, the first sense coil comprising two or more sine lobes arranged within the first and the second excitation coil portions;
a second sense coil to carry a second sense signal induced by the excitation signal, the second sense coil comprising two or more cosine lobes arranged within the first and the second excitation coil portions;
a second coil structure of a second inductive angular-position sensor, the second coil structure comprising conductive traces on and/or in the one or more planes of the support structure, the second coil structure arranged about the axis of rotation, the second coil structure comprising:
a second excitation coil to carry a second excitation signal, the second excitation coil comprising a third excitation coil portion and a fourth excitation coil portion, the third excitation coil portion arranged around a third arc band section of the support structure, the fourth excitation coil portion arranged around a fourth arc band section of the support structure, the fourth arc band section opposite the third arc band section;
a third sense coil to carry a third sense signal induced by the second excitation signal, the third sense coil comprising two or more sine lobes arranged within the third and the fourth excitation coil portions; and
a fourth sense coil to carry a fourth sense signal induced by the second excitation signal, the fourth sense coil comprising two or more cosine lobes arranged within the third and the fourth excitation coil portion.
